(19) United States
(12) Patent Application Publication
(10) Pub. No.: US 2023/0024916 A1
(43) Pub. Date: Jan. 26, 2023

(54) ELECTRIC WORK MACHINE

(71) Applicant: MAKITA CORPORATION, Anjo-shi, Aichi (JP)

(72) Inventors: Yuki ISHIMARU, Anjo-shi (JP); Tetsuya SHIMOOKA, Anjo-shi (JP)

(73) Assignee: MAKITA CORPORATION, Anjo-shi, Aichi (JP)

(21) Appl. No.: 17/790,810

(22) PCT Filed: Dec. 4, 2020
(86) PCT No.: PCT/JP2020/045208

§ 371 Date: Jul. 5, 2022

(30) Foreign Application Priority Data
Mar. 4, 2020 (JP) 2020-036744

(51) Int. Cl. B25F 5/02; H01M 50/247; H01M 50/242

(52) U.S. Cl. CPC B25F 5/02; H01M 50/247; H01M 50/242; A01G 3/086

(57) ABSTRACT

An electric work machine includes a housing with improved strength. An electric work machine includes a motor compartment accommodating a motor, a battery holder that receives a battery for supplying electric power to the motor, a grip grippable by an operator, and a sheet for reinforcement located in a bend. The bend is in at least one of the motor compartment, the battery holder, or the grip or connects two of the motor compartment, the battery holder, or the grip.

### FIELD

The present disclosure relates to an electric work machine.

### BACKGROUND

In the technical field of electric work machines, a known work machine is described in, for example, Japanese Patent No. 5210487.

### BRIEF SUMMARY

### Technical Problem

An electric work machine includes a housing formed from a synthetic resin. A battery is attached to the electric work machine to facilitate a smooth operation of the electric work machine by the user. However, the electric work machine with the battery can be heavier. When the electric work machine falls, the housing may at least partially receive an excessive impact. This may damage at least a part of the housing.

One or more aspects of the present disclosure are directed to improving the strength of the housing.

### Solution to Problem

A first aspect of the present disclosure provides an electric work machine, including:

a motor compartment accommodating a motor;

a battery holder configured to receive a battery for supplying electric power to the motor; a grip grippable by an operator; and

a sheet for reinforcement, the sheet being located in a bend, the bend being in at least one of the motor compartment, the battery holder, or the grip or connecting two of the motor compartment, the battery holder, or the grip.

A second aspect of the present disclosure provides an electric work machine, including:

a motor compartment accommodating a motor;

a battery holder configured to receive a battery for supplying electric power to the motor; a grip grippable by an operator; and

a sheet having higher tensile strength than at least one of the motor compartment, the battery holder, or the grip, the sheet being located in a bend, the bend being in at least one of the motor compartment, the battery holder, or the grip or connecting two of the motor compartment, the battery holder, or the grip.

A third aspect of the present disclosure provides an electric work machine, including:

a housing accommodating a motor, configured to hold a battery for supplying electric power to the motor, and including a bend; and

a reinforcing member comprising a material different from a material of the housing and reinforcing the bend.

### Advantageous Effects

The electric work machine according to the above aspects of the present disclosure includes the housing with improved strength.

### BRIEF DESCRIPTION OF DRAWINGS

FIG. 1 is a side view of an electric work machine according to a first embodiment.

FIG. 2 is a perspective view of a housing in the first embodiment.

FIG. 3 is an exploded perspective view of the housing and an elastomer portion in the first embodiment.

FIG. 4 is a rear view of the housing in the first embodiment.

FIG. 5 is a right view of the housing in the first embodiment.

FIG. 6 is a left view of a right housing in the first embodiment.

FIG. 7 is an enlarged partial left view of the right housing in the first embodiment.

FIG. 8 is a schematic diagram of a sheet in the first embodiment.

FIG. 9 is a diagram describing the effects of the sheet in the first embodiment.

FIG. 10 is an enlarged partial left view of a right housing in a modification of the first embodiment.

FIG. 11 is an enlarged partial left view of a right housing in a modification of the first embodiment.

FIG. 12 is a side view of an electric work machine according to a second embodiment.

FIG. 13 is a left view of a right housing in the second embodiment.

FIG. 14 is an enlarged partial left view of the right housing in the second embodiment.

FIG. 15 is a diagram describing the effects of a sheet in the second embodiment.

FIG. 16 is an enlarged partial left view of a right housing in a modification of the second embodiment.

FIG. 17 is a side view of an electric work machine according to a third embodiment.

FIG. 18 is a left view of a right housing in the third embodiment.

FIG. 19 is an enlarged partial left view of the right housing in the third embodiment.

FIG. 20 is a diagram describing the effects of a sheet in the third embodiment.

FIG. 21 is a perspective view of an electric work machine according to a fourth embodiment.

FIG. 22 is a rear view of the electric work machine according to the fourth embodiment.

FIG. 23 is a partially cut-away view of a grip in the fourth embodiment.

FIG. 24 is a partial sectional view of the grip in the fourth embodiment.

FIG. 25 is a diagram describing the effects of a sheet in the fourth embodiment.

FIG. 26 is a schematic diagram of a sheet in a fifth embodiment.

FIG. 27 is a sectional view of a sheet in a sixth embodiment.

FIG. 28 is a schematic diagram of a sheet in a seventh embodiment.

### DETAILED DESCRIPTION

Although one or more embodiments of the present disclosure will now be described with reference to the drawings, the present disclosure is not limited to the present embodiments. The components in the embodiments described below may be combined as appropriate. One or more components may be eliminated.

In the embodiments, the positional relationships between the components will be described using the directional terms such as right and left (or lateral), front and rear, and up and down (or vertical). The terms indicate relative positions or directions with respect to the center of an electric work machine. The lateral direction, the front-rear direction, and the vertical direction are orthogonal to one another.

The electric work machine is a work machine including a motor and a work component. The motor is driven by electric power. The work component is driven by power generated by the motor. The electric work machine is, for example, a power tool or an outdoor power tool. The work component of the power tool includes a tip tool such as a drill or a grinding disc. The work component of the outdoor power tool includes a tip tool such as a blade or a nozzle.

### First Embodiment

An electric work machine 1 according to the present embodiment is an impact driver as an example of a power tool.

### Electric Work Machine

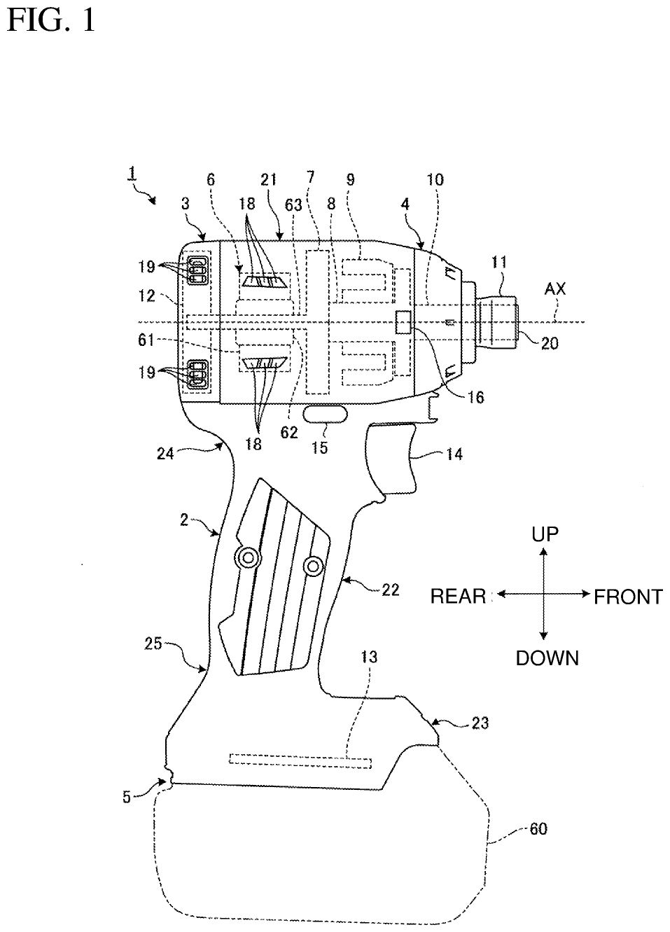

FIG. 1 is a side view of the electric work machine 1 according to the present embodiment. The electric work machine 1 includes a housing 2, a rear case 3, a hammer case 4, a battery mount 5, a motor 6, a reducer 7, a spindle 8, a striker 9, an anvil 10, a chuck sleeve 11, a fan 12, a controller 13, a trigger switch 14, a forward-reverse switch lever 15, and lamps 16.

The housing 2 is formed from a synthetic resin. The housing 2 includes a motor compartment 21, a grip 22, and a battery holder 23. The grip 22 is located below the motor compartment 21. The battery holder 23 is located below the grip 22. As described later, the housing 2 includes a pair of housing halves.

The motor compartment 21 is cylindrical. The motor compartment 21 accommodates the motor 6.

The grip 22 is grippable by a user of the electric work machine 1. The user (operator) can grip the grip 22. The grip 22 is cylindrical. The grip 22 is connected to a lower portion of the motor compartment 21. The grip 22 protrudes downward from the motor compartment 21. The grip 22 is vertically elongated.

The battery holder 23 is connected to the lower end of the grip 22. The battery mount 5 is located in a lower portion of the battery holder 23. A battery 60 for supplying electric power to the motor 6 is attached to the battery mount 5. The battery 60 is attached to the battery holder 23 with the battery mount 5. The battery 60 is detachable from the battery mount 5. The battery holder 23 holds the battery 60 that can supply electric power to the motor 6 with the battery mount 5.

In the front-rear direction and the lateral direction, the motor compartment 21 has a larger outer dimension than the grip 22. In the front-rear direction and the lateral direction, the battery holder 23 has a larger outer dimension than the grip 22.

The grip 22 includes a bend 24 and a bend 25. The bend 24 connects to the motor compartment 21. The bend 25 connects to the battery holder 23. The bend 24 is located at the upper end of the grip 22. The bend 25 is located at the lower end of the grip 22. The grip 22 connects to the motor compartment 21 with the bend 24 in between. The grip 22 connects to the battery holder 23 with the bend 25 in between.

The bend 24 is a neck portion of the housing 2 located at the boundary between the grip 22 and the motor compartment 21. The bend 24 is located at least in a rear portion of the upper end of the grip 22 and connects to a rear portion of the motor compartment 21. The bend 25 is a neck portion of the housing 2 located at the boundary between the grip 22 and the battery holder 23. The bend 25 is located at least in a rear portion of the lower end of the grip 22 and connects to a rear portion of the battery holder 23.

The rear case 3 is formed from a synthetic resin. The rear case 3 is located behind the motor compartment 21. The rear case 3 accommodates at least a part of the fan 12. The rear case 3 covers a rear opening of the motor compartment 21.

The motor compartment 21 has inlets 18. The rear case 3 has outlets 19. Air outside the housing 2 flows into an internal space of the housing 2 through the inlets 18. Air from the internal space of the housing 2 flows out of the housing 2 through the outlets 19.

The hammer case 4 is formed from a metal. The hammer case 4 is located in front of the motor compartment 21. The hammer case 4 is cylindrical. The hammer case 4 has a smaller inner diameter in its front portion than in its rear portion. The rear portion of the hammer case 4 is received in a front opening of the motor compartment 21. The rear portion of the hammer case 4 is fitted into the motor compartment 21.

The hammer case 4 accommodates at least parts of the reducer 7, the spindle 8, the striker 9, and the anvil 10.

The motor 6 is a power source for the electric work machine 1. The motor 6 is a brushless inner-rotor motor. The motor 6 includes a cylindrical stator 61, a rotor 62, and a rotor shaft 63. The rotor 62 is located inside the stator 61. The rotor shaft 63 is integral with the rotor 62. The rotor 62 and the rotor shaft 63 rotate about a rotation axis AX. The rotation axis AX of the motor 6 extends in the front-rear direction.

The reducer 7 is located in front of the motor 6. The reducer 7 connects the rotor shaft 63 and the spindle 8 together. The reducer 7 transmits a rotational force generated by the motor 6 to the spindle 8. The reducer 7 rotates the spindle 8 at a lower rotational speed than the rotor shaft 63. The reducer 7 includes a planetary gear assembly.

The spindle 8 is located frontward from the motor 6. The spindle 8 is located at least partially in front of the reducer 7. The spindle 8 rotates about the rotation axis AX with the rotational force generated by the motor 6.

The striker 9 strikes the anvil 10 in the rotation direction in response to rotation of the spindle 8. The striker 9 includes a hammer, balls, and a coil spring. The hammer surrounds the spindle 8. The balls are located between the spindle 8 and the hammer. The coil spring is supported by the spindle 8 and the hammer.

The anvil 10 is located in front of the striker 9. The anvil 10 has an insertion hole 20. The insertion hole 20 receives a tip tool. The insertion hole 20 is formed at the front end of the anvil 10. The anvil 10 rotates about the rotation axis AX. The anvil 10 is rotatable with the hammer in the striker 9.

When the anvil 10 receives a higher load in a screwing operation, the anvil 10 may fail to rotate with the power generated by the motor 6 alone. The rotation of the anvil 10 and the hammer then stops. Although the hammer stops rotating, the spindle 8 continues to rotate with a rotational force generated by the motor 6. When the hammer stops rotating and the spindle 8 rotates, the balls and the hammer move backward. The coil spring generates an elastic force for moving the hammer forward. The hammer moving backward then moves forward under the elastic force from the coil spring. When moving forward, the hammer receives a force in the rotation direction from the balls and thus moves forward while rotating. The anvil 10 is thus struck by the hammer in the rotation direction. The anvil 10 receives the power from the motor 6 and the inertial force from the hammer. The anvil 10 thus rotates with high torque about the rotation axis AX.

The chuck sleeve 1I surrounds a front portion of the anvil 10. The chuck sleeve 11 holds the tip tool placed in the insertion hole 20.

The fan 12 is located behind the motor 6. The fan 12 is located inside the rear case 3. The fan 12 generates an airflow for cooling the motor 6. The fan 12 is fixed to a rear portion of the rotor shaft 63. The fan 12 rotates as the rotor shaft 63 rotates. Air outside the housing 2 thus flows into the internal space of the housing 2 through the inlets 18 and flows through the internal space of the housing 2 to cool the motor 6. The air passing through the internal space of the housing 2 flows out of the housing 2 through the outlets 19.

The controller 13 is accommodated in the battery holder 23. The controller 13 outputs control signals for controlling the motor 6. The controller 13 includes a board on which multiple electronic components are mounted. Examples of the electronic components mounted on the board include a processor such as a central processing unit (CPU), a nonvolatile memory such as a read-only memory (ROM) or a storage device, a volatile memory such as a random-access memory (RAM), a transistor, and a resistor.

The trigger switch 14 is located on the grip 22. The trigger switch 14 is operable by the user to activate the motor 6. The trigger switch 14 protrudes frontward from an upper front portion of the grip 22. The trigger switch 14 is operable by the user to switch the motor 6 between the driving state and the stopped state.

The forward-reverse switch lever 15 is located in an upper portion of the grip 22. The forward-reverse switch lever 15 is operable by the user to switch the rotation direction of the motor 6 between forward and reverse. This operation switches the rotation direction of the spindle 8.

The lamps 16 are located on the right and the left of the motor compartment 21. The lamps 16 emit illumination light to illuminate ahead of the electric work machine 1. The lamps 16 are, for example, light-emitting diodes (LEDs).

### Housing and Sheet

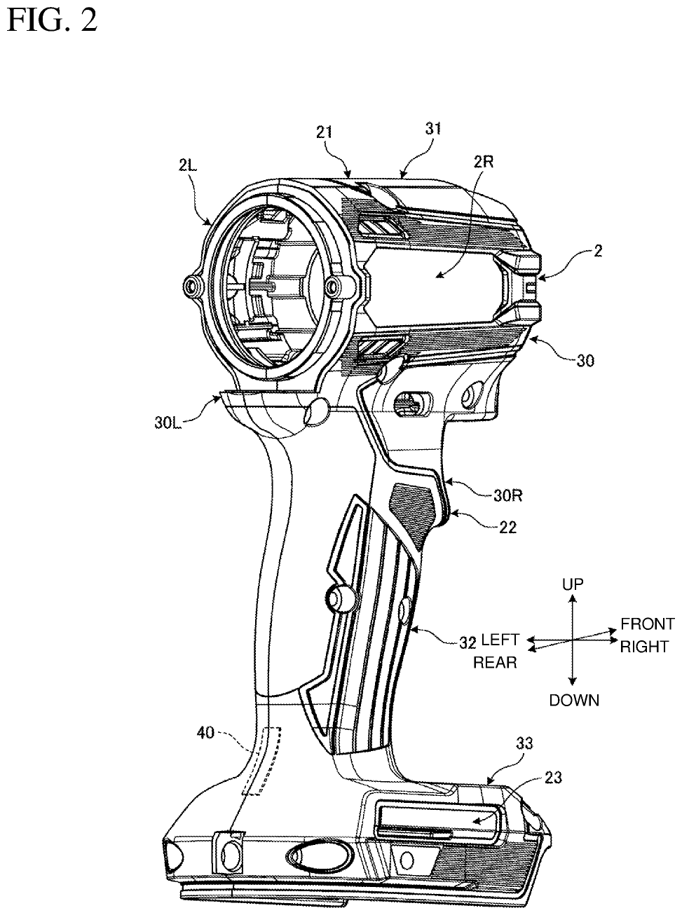

FIG. 2 is a perspective view of the housing 2 in the present embodiment. The housing 2 includes a pair of housing halves. The housing 2 includes a left housing 2L and a right housing 2R. The right housing 2R is located on the right of the left housing 2L. The left housing 2L and the right housing 2R are fastened with screws (not shown).

The electric work machine 1 includes an elastomer portion 30. The elastomer portion 30 covers at least a part of the surface of the housing 2. The elastomer portion 30 is softer than the housing 2. The elastomer portion 30 in the present embodiment is formed from a thermoplastic elastomer portion or rubber.

The elastomer portion 30 includes a left elastomer portion 30L and a right elastomer portion 30R. The left elastomer portion 30L covers at least a part of the surface of the left housing 2L. The right elastomer portion 30R covers at least a part of the surface of the right housing 2R.

The elastomer portion 30 includes a motor elastomer portion 31, a grip elastomer portion 32, and a battery elastomer portion 33. The motor elastomer portion 31 covers at least a part of the surface of the motor compartment 21. The grip elastomer portion 32 covers at least a part of the surface of the grip 22. The battery elastomer portion 33 covers at least a part of the surface of the battery holder 23.

The left elastomer portion 30L includes a left portion of the motor elastomer portion 31, a left portion of the grip elastomer portion 32, and a left portion of the battery elastomer portion 33. The right elastomer portion 30R includes a right portion of the motor elastomer portion 31, a right portion of the grip elastomer portion 32, and a right portion of the battery elastomer portion 33.

The elastomer portion 30 has an anti-slip function. The grip elastomer portion 32 on at least a part of the surface of the grip 22 allows the user to easily grip the grip 22. In addition, the elastomer portion 30 reduces the likelihood of damaging the surface of the housing 2.

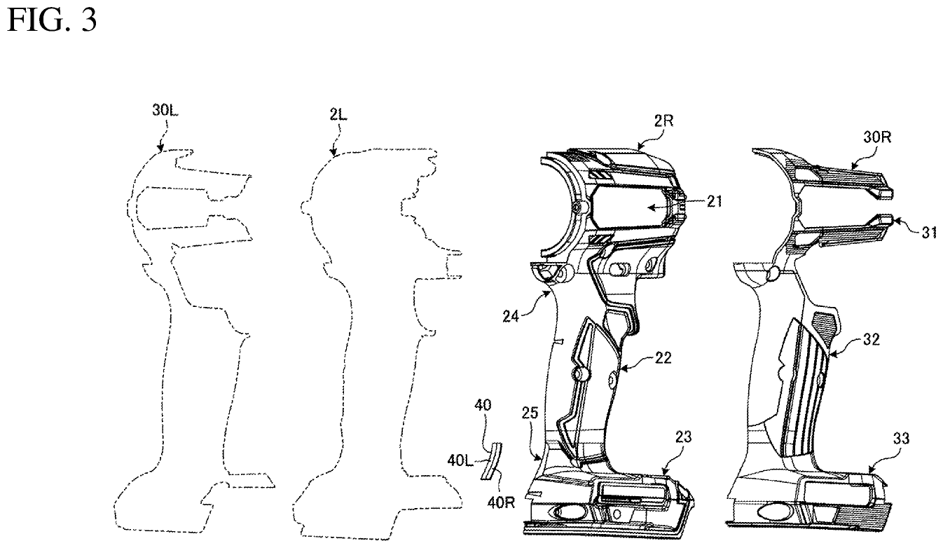

FIG. 3 is an exploded perspective view of the housing 2 and the elastomer portion 30 in the present embodiment. As shown in FIGS. 2 and 3, the electric work machine 1 includes a reinforcing sheet 40. The sheet 40 is located in the bend 25 in the grip 22. The sheet 40 reinforces the bend 25. The elastomer portion 30 covers the sheet 40.

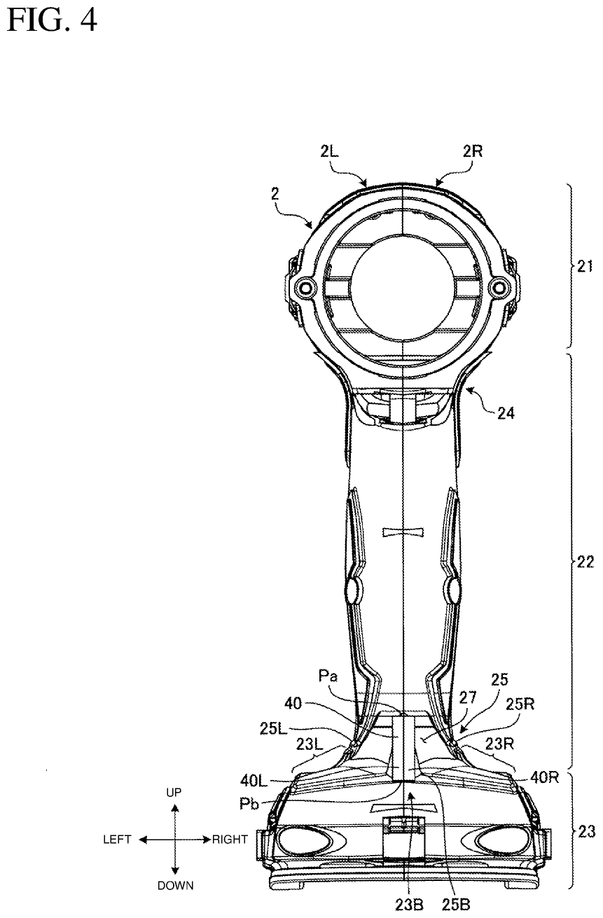

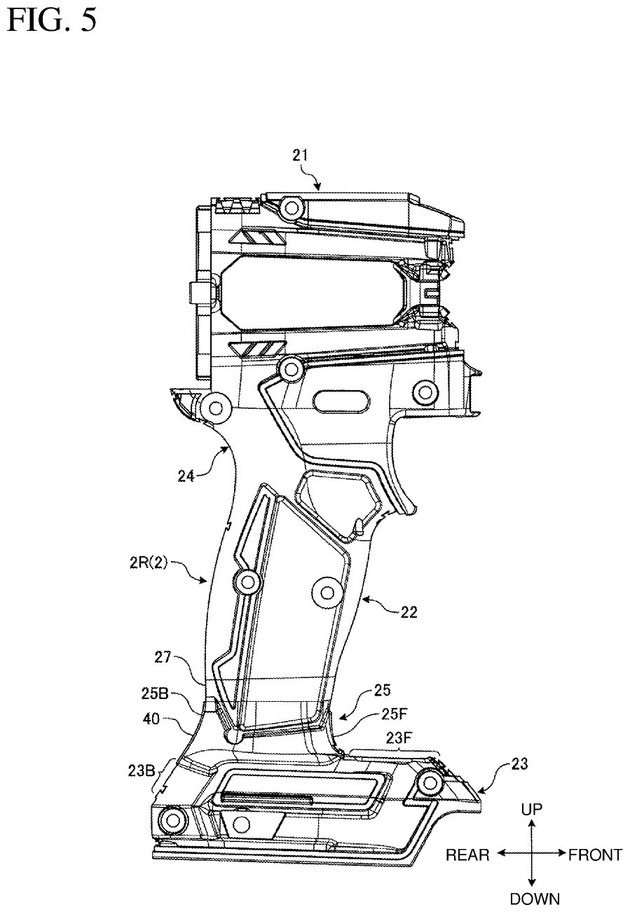

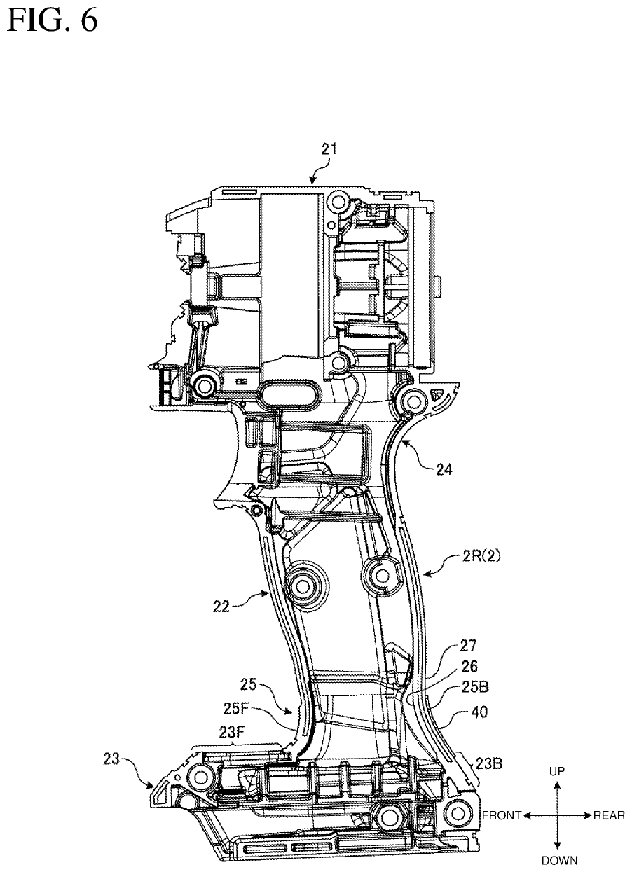

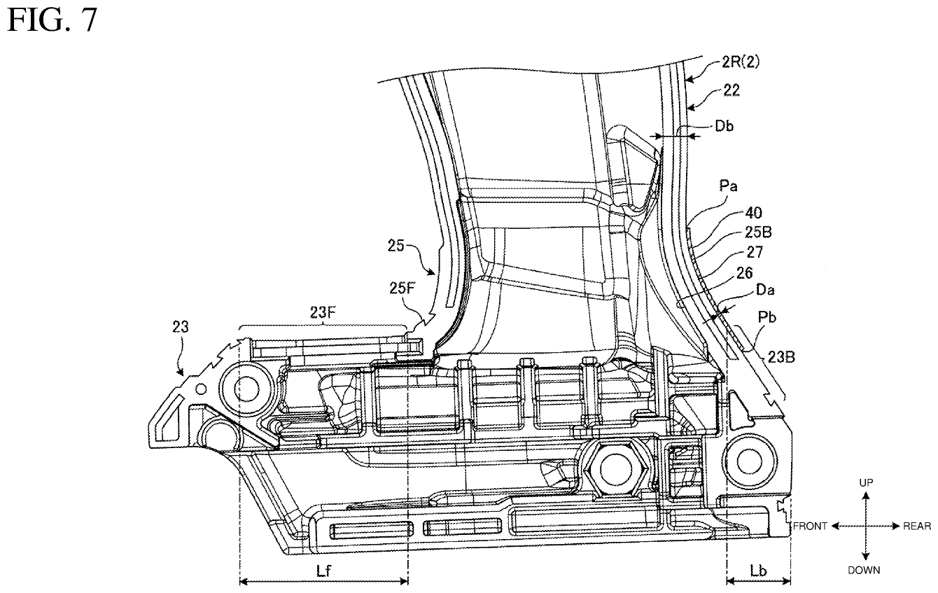

FIG. 4 is a rear view of the housing 2 in the present embodiment. FIG. 5 is a right view of the housing 2 in the present embodiment. FIG. 6 is a left view of the right housing 2R in the present embodiment. FIG. 7 is an enlarged partial left view of the right housing 2R in the present embodiment. In FIGS. 4 to 7, the elastomer portion 30 is not shown.

The housing 2 has the internal space. The motor compartment 21 is cylindrical and has an internal space in which the motor 6 is located. The grip 22 is cylindrical and has an internal space in which at least a part of the trigger switch 14 and a cable are located. The battery holder 23 has an internal space in which the controller 13 is located.

The grip 22 has an inner surface 26 and an outer surface 27. The inner surface 26 faces the internal space of the grip 22. The outer surface 27 faces the space external to the grip 22.

The grip 22 is vertically elongated. The grip 22 connects to the battery holder 23 with the bend 25 in between. The bend 25 includes a front bend 25F and a rear bend 25B in the front-rear direction. The front bend 25F is located frontward from the center of the grip 22. The rear bend 25B is located rearward from the center of the grip 22. The bend 25 includes a left bend 25L and a right bend 25R in the lateral direction. The left bend 25L is located leftward from the center of the grip 22. The right bend 25R is located rightward from the center of the grip 22.

In the front-rear direction and the lateral direction, the battery holder 23 has a larger outer dimension than the grip 22. The battery holder 23 includes a front extension 23F and a rear extension 23B in the front-rear direction. The front extension 23F extends frontward from the front bend 25F. The rear extension 23B extends rearward from the rear bend 25B. The battery holder 23 includes a left extension 23L and a right extension 23R in the lateral direction. The left extension 23L extends leftward from the left bend 25L. The right extension 23R extends rightward from the right bend 25R.

As shown in FIG. 7, the front extension 23F has a dimension Lf larger than a dimension Lb of the rear extension 23B in the front-rear direction.

The sheet 40 in the present embodiment is located on the outer surface 27 of the rear bend 25B.

The sheet 40 has a rectangular outer shape. The sheet 40 has a vertical dimension larger than its lateral dimension. The sheet 40 is at least partially located on the centerline of the housing 2 in the lateral direction. In the present embodiment, the sheet 40 has the center aligned with the center of the housing 2 in the lateral direction. The sheet 40 in the present embodiment includes a left sheet 40L and a right sheet 40R. The left sheet 40L is located on the left housing 2L. The right sheet 40R is located on the right housing 2R. The sheet 40 has a smaller dimension than the grip 22 in the lateral direction.

The sheet 40 has its upper end at a defined position Pa on the grip 22 above the bend 25. The sheet 40 has its lower end at a defined position Pb on the battery holder 23 below the bend 25. The defined position Pa is defined below the middle of the grip 22 in the vertical direction. The defined position Pb is defined above the middle of the battery holder 23 in the vertical direction.

As shown in FIG. 7, the sheet 40 has a thickness Da smaller than a thickness Db of the grip 22. The thickness Db of the grip 22 is the distance between the inner surface 26 and the outer surface 27. In the present embodiment, the thickness Da of the sheet 40 is from 3.3 to 50.0% inclusive of the thickness Db of the grip 22. For example, when the thickness Db of the grip 22 is 3.0 mm, the thickness Da of the sheet 40 is from 0.1 to 1.5 mm inclusive.

The thickness Da of the sheet 40 may be from 10 to 30% inclusive of the thickness Db of the grip 22. For example, when the thickness Db of the grip 22 is 3.0 mm, the thickness Da of the sheet 40 may be from 0.1 to 1.0 mm inclusive. The thickness Db of the grip 22 may be from 2.0 to 5.0 mm inclusive.

The sheet 40 has higher tensile strength than the synthetic resin contained in the grip 22. The tensile strength of the sheet 40 in the present embodiment is at least twice that of the synthetic resin contained in the grip 22.

The synthetic resin contained in the housing 2 including the grip 22 is, for example, a nylon resin, a polyamide resin, a polycarbonate resin, a polypropylene resin, or an acrylonitrile-butadiene-styrene copolymer synthetic resin. Fibers such as glass fibers (fillers) may be dispersed in the synthetic resin described above as a material for the housing 2. The tensile strength of the synthetic resin contained in the housing 2 is, for example, from 100 to 200 MPa inclusive. When the tensile strength of the synthetic resin contained in the grip 22 is 200 MPa, the tensile strength of the sheet 40 may be 400 MPa or more. The tensile strength of the sheet 40 may be, for example, from 400 to 2000 MPa inclusive.

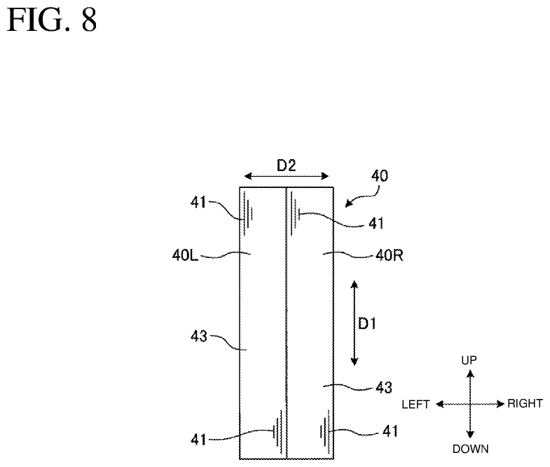

FIG. 8 is a schematic diagram of the sheet 40 in the present embodiment. The sheet 40 is formed from a material different from the housing 2. As shown in FIG. 8, the sheet 40 is a unidirectional (UD) sheet including abase 43 and fibers 41. The base 43 contains a synthetic resin. The fibers 41 are located in the base 43 and extend in a predetermined extending direction D1. The base 43 is a sheet. The synthetic resin contained in the base 43 is, for example, a polyamide resin. Multiple fibers 41 are located inside the base 43. The fibers 41 are, for example, carbon fibers or glass fibers. The sheet 40 in the present embodiment is a UD sheet formed from a carbon fiber reinforced plastic.

The sheet 40 may be a UD sheet formed from a glass fiber reinforced plastic. The sheet 40 has higher tensile strength in the extending direction D1 than the sheet 40 in a width direction D2 orthogonal to the extending direction D1. The sheet 40 has higher tensile strength in the extending direction D1 than the synthetic resin contained in the grip 22.

The sheet 40 in the present embodiment includes the left sheet 40L and the right sheet 40R. The left sheet 40L is located on the left housing 2L. The right sheet 40R is located on the right housing 2R. The left sheet 40L and the right sheet 40R are splittable. The left sheet 40L and the right sheet 40R may be integral.

The sheet 40 is fixed to the outer surface 27 of the rear bend 25B. The sheet 40 is located on the outer surface 27 of the rear bend 25B with the vertical direction of the housing 2 aligned with the extending direction D1 of the fibers 41. The sheet 40 is bonded to the outer surface 27 with, for example, an adhesive. The sheet 40 may be joined to the outer surface 27 by a joining technique such as heat welding.

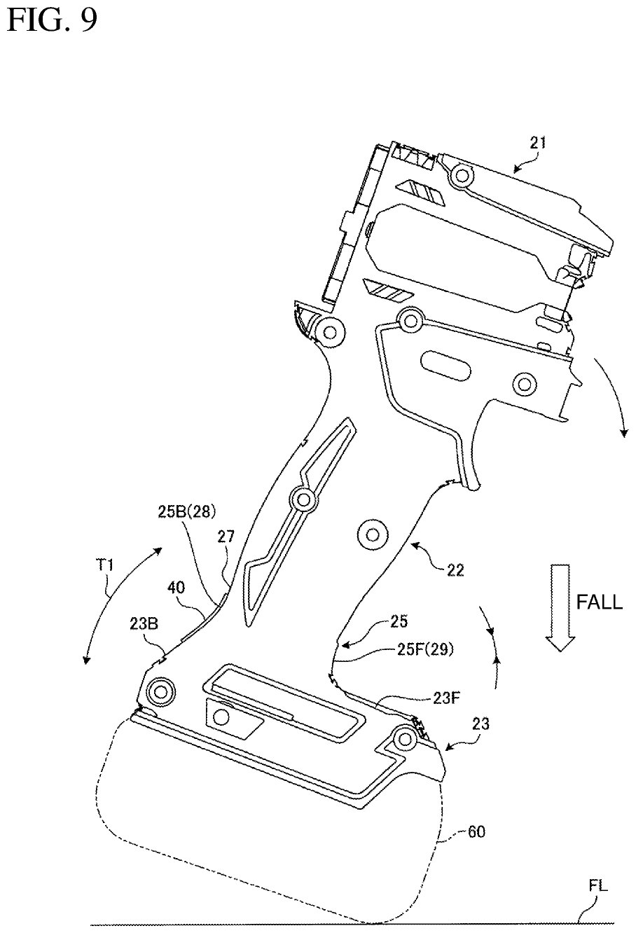

FIG. 9 is a diagram describing the effects of the sheet 40 in the present embodiment. As shown in FIG. 9, when the electric work machine 1 falls and the battery 60 hits a floor surface FL, the motor compartment 21 is displaced downward. The grip 22 may then deform and bend forward with respect to the battery holder 23. In other words, when the battery 60 receives an impact from the floor surface FL, the bend 25 may deform and bend.

The bend 25 then has a portion that expands, and another portion that compresses. In the example below, when the bend 25 deforms and bends, the portion of the bend 25 that expands is referred to as an expandable portion 28 for convenience, and the portion of the bend 25 that compresses is referred to as a compressible portion 29 for convenience. The expandable portion 28 expands under the deformation of the bend 25. The compressible portion 29 compresses under the deformation of the bend 25.

The sheet 40 is located on the expandable portion 28. The expandable portion 28 in the present embodiment includes the outer surface 27 of the rear bend 25B and the inner surface 26 of the front bend 25F. The compressible portion 29 includes the inner surface 26 of the rear bend 25B and the outer surface 27 of the front bend 25F.

The bend 25 has the inner surface 26 and the outer surface 27. The inner surface 26 faces an internal space of the bend 25. The outer surface 27 faces the space external to the bend 25. As shown in FIG. 9, when the bend 25 deforms and bends, the outer surface 27 of the rear bend 25B expands in an expansion direction T1. The expandable portion 28 in the present embodiment includes the outer surface 27 of the rear bend 25B. The sheet 40 is located on the outer surface 27 of the rear bend 25B that is the expandable portion 28.

In the example shown in FIG. 9, the expansion direction T1 is substantially aligned with the vertical direction. The sheet 40 is located on the outer surface 27 of the rear bend 25B with the expansion direction T1 of the outer surface 27 of the rear bend 25B aligned with the extending direction D1 of the fibers 41.

The sheet 40 has higher tensile strength in the expansion direction T1 of the expandable portion 28 than the synthetic resin contained in the grip 22. Although the outer surface 27 of the rear bend 25B may deform and expand in the expansion direction T1 in the falling electric work machine 1, the sheet 40 reduces the likelihood of deforming the outer surface 27 of the rear bend 25B.

In the present embodiment, the reinforcing sheet 40 is located in the bend 25 in the grip 22. This strengthens the bend 25. Although the electric work machine 1 falls and an excess impact is applied to the grip 22, the bend 25 is thus less likely to deform. This reduces the likelihood of damaging the grip 22.

The electric work machine 1 according to the embodiment includes the battery holder 23 to which the battery 60 is attached. The battery 60 attached to the electric work machine 1 allows the user to use the electric work machine 1 more smoothly than when an alternating-current (AC) power supply is used. When an AC power supply is used to power the electric work machine 1, a power cable is to connect the AC power supply to the electric work machine 1. The power cable may reduce smooth operability of the electric work machine for the user. The battery 60 attached to the electric work machine 1 allows the user to use the electric work machine 1 more smoothly with no power cable. However, when the battery 60 is attached to the electric work machine 1, the weight of the electric work machine 1 increases. When the electric work machine 1 falls, the impact applied to the grip 22 is then greater. In the present embodiment, the reinforcing sheet 40 reduces the likelihood of damaging the grip 22, although an excess impact is applied to the grip 22.

The sheet 40 has higher tensile strength than the synthetic resin contained in the grip 22. Although the bend 25 may deform and expand, the sheet 40 thus reduces the likelihood of deformation of the bend 25. This reduces the likelihood of damaging the grip 22.

The tensile strength of the sheet 40 is at least twice that of the synthetic resin contained in the grip 22. Although the bend 25 may deform and expand, the sheet 40 thus effectively reduces the likelihood of deformation of the bend 25.

The sheet 40 is located on the expandable portion 28 of the bend 25. In the present embodiment, deformation of the bend 25 causes expansion of the outer surface 27 of the rear bend 25B. The sheet 40 is located on the outer surface 27 of the rear bend 25B. The sheet 40 is located on the expandable portion 28. This effectively reduces the likelihood of deformation of the expandable portion 28.

The sheet 40 has higher tensile strength in the expansion direction T1 of the expandable portion 28 than the synthetic resin contained in the grip 22. This effectively reduces the likelihood of deformation of the expandable portion 28.

The sheet 40 is a UD sheet including the base 43 and the fibers 41. The base 43 is formed from a synthetic resin. The fibers 41 are located in the base 43 and extends in the predetermined extending direction D1. The sheet 40 is located on the rear bend 25B with the expansion direction T1 of the expandable portion 28 aligned with the extending direction D1 of the fibers 41. The sheet 40 thus exhibits high tensile strength in the expansion direction T1. This effectively reduces the likelihood of deformation of the rear bend 25B.

The bend 25 in the present embodiment includes the front bend 25F and the rear bend 25B in the front-rear direction. The front bend 25F is located frontward from the center of the grip 22. The rear bend 25B is located rearward from the center of the grip 22. The battery holder 23 includes the front extension 23F and the rear extension 23B. The front extension 23F extends frontward from the front bend 25F. The rear extension 23B extends rearward from the rear bend 25B. The front extension 23F has the dimension Lf larger than the dimension Lb of the rear extension 23B. In the housing 2 having such a shape, the outer surface 27 of the rear bend 25B is likely to become the expandable portion 28 when the electric work machine 1 falls. In the present embodiment, the sheet 40 is located on the outer surface 27 of the rear bend 25B that is to be the expandable portion 28. This effectively reduces the likelihood of deformation of the rear bend 25B.

The sheet 40 has the thickness Da smaller than the thickness Db of the grip 22. The grip 22 is reinforced by the sheet 40 with the thickness Da. This strengthens the grip 22 without increasing its size. In addition, this strengthens the grip 22 without increasing the weight of the electric work machine 1. When, for example, the thickness Db of the grip 22 is increased or ribs are included in the internal space of the grip 22 to improve the strength of the grip 22, the grip 22 may become larger, or the weight of the electric work machine 1 may increase. When the housing 2 with the large thickness Db is manufactured by injection molding, molding defects are likely to occur. When a cable or electronic components are located in the internal space of the grip 22, ribs may not be included easily. In the present embodiment, the grip 22 is reinforced using the sheet 40 to improve the strength of the grip 22 without increasing the size and the weight of the grip 22.

The thickness Da of the sheet 40 is from 3.3 to 50.0% inclusive of the thickness Db of the grip 22. The thickness Da of the sheet 40 is sufficiently thinner than the thickness Db of the grip 22. This reduces the likelihood of a large step forming between the sheet 40 and the outer surface 27. This reduces the likelihood that the user feels discomfort when gripping the grip 22.

In the present embodiment, the sheet 40 located on the outer surface 27 of the bend 25 is covered with the elastomer portion 30. The sheet 40 is hidden by the elastomer portion 30. This improves the aesthetics of the electric work machine 1 through visual perception. The elastomer portion 30 reduces the likelihood that the sheet 40 is separate from the housing 2.

The housing 2 in the present embodiment includes the motor compartment 21, the battery holder 23, and the grip 22. The housing 2 including the motor compartment 21, the battery holder 23, and the grip 22 is integrally molded by, for example, injection molding. The synthetic resin is injected into the mold for forming the housing 2. This allows the housing 2 to be integral.

### Modifications

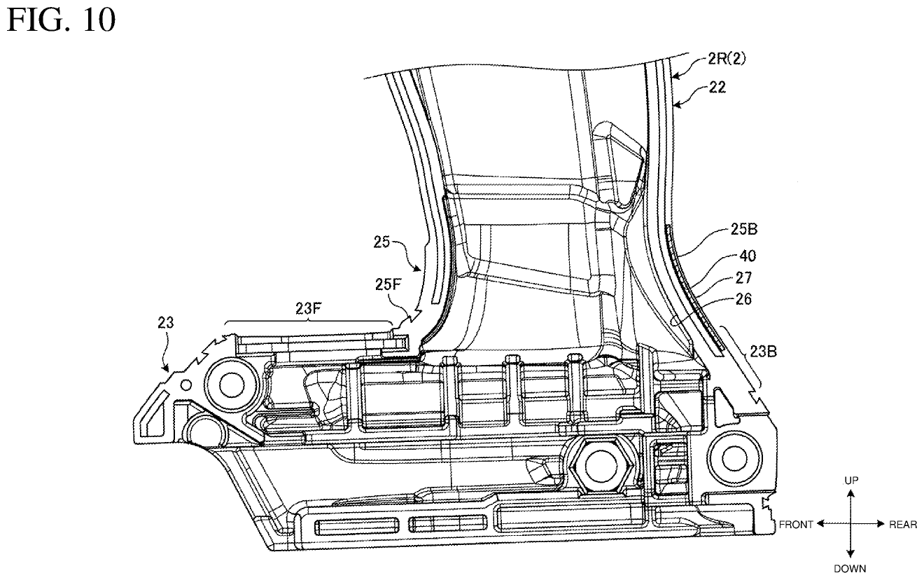

FIG. 10 is an enlarged partial left view of the right housing 2R in a modification of the present embodiment. In the example shown in FIG. 10, the sheet 40 is located inside the rear bend 25B between the inner surface 26 and the outer surface 27 of the rear bend 25B. The sheet 40 is located inside the rear bend 25B by, for example, insert molding. After the sheet 40 is loaded as an insert into the mold for forming the housing 2, the synthetic resin for forming the housing 2 is injected into the mold to form the housing 2 with the sheet 40 located inside the rear bend 25B.

As in the embodiment described above, when the electric work machine 1 falls and a front portion of the battery 60 hits the floor surface FL, the rear bend 25B may deform and expand in the expansion direction T1. As shown in FIG. 10, the sheet 40 is located inside the rear bend 25B. This reduces the likelihood of deformation of the rear bend 25B. This reduces the likelihood of damaging the bend 25. In addition, the sheet 40 inside the bend 25 improves the aesthetics of the electric work machine 1 through visual perception.

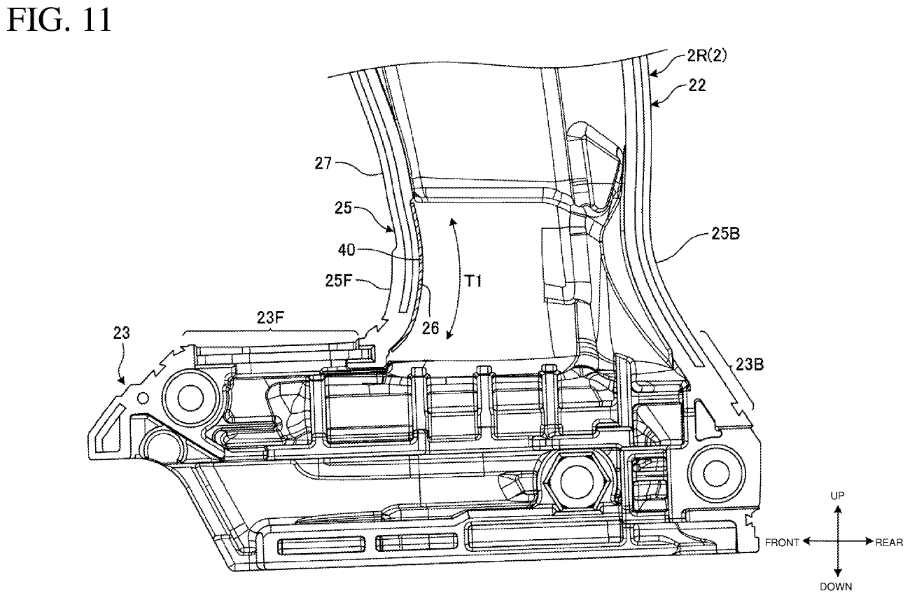

FIG. 1 is an enlarged partial left view of the right housing 2R in a modification of the present embodiment. In the embodiment described above, the sheet 40 is located on the rear bend 25B. As shown in FIG. 11, the sheet 40 may be located in the front bend 25F. In the example shown in FIG. 11, the sheet 40 is located on the inner surface 26 of the front bend 25F.

When the electric work machine 1 falls and the front portion of the battery 60 hits the floor surface FL, the inner surface 26 of the front bend 25F may deform and expand in the expansion direction T1. In other words, the expandable portion 28 may include the inner surface 26 of the front bend 25F. As shown in FIG. 11, the sheet 40 is located on the inner surface 26 of the front bend 25F. This reduces the likelihood of deformation of the front bend 25F. This reduces the likelihood of damaging the bend 25. The sheet 40 on the inner surface 26 of the bend 25 improves the adhesion between the sheet 40 and the front bend 25F.

The sheet 40 may be located inside the front bend 25F between the inner surface 26 and the outer surface 27 of the front bend 25F.

In the embodiment described above, the grip 22 connects to the motor compartment 21 with the bend 24 in between. The sheet 40 may be located in the bend 24 that connects to the motor compartment 21.

### Second Embodiment

The same or corresponding components as those in the above embodiment are given like reference numerals herein, and will be described briefly or will not be described. An electric work machine 101 according to the present embodiment is a grinder as an example of a power tool.

### Electric Work Machine

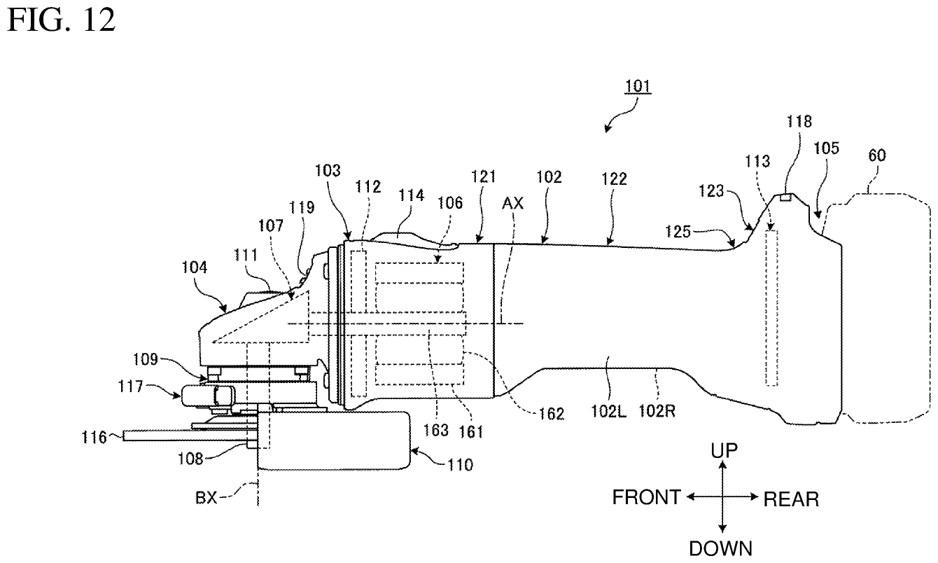

FIG. 12 is a side view of the electric work machine 101 according to the present embodiment. The electric work machine 101 includes a housing 102, a gear housing cover 103, a gear housing 104, a battery mount 105, a motor 106, a reducer 107, a spindle 108, a bearing box 109, a wheel cover 110, a lock switch 111, a fan 112, a controller 113, and a drive switch 114.

The housing 102 is formed from a synthetic resin. The housing 102 includes a motor compartment 121, a grip 122, and a battery holder 123. The grip 122 is located behind the motor compartment 121. The battery holder 123 is located behind the grip 122.

The motor compartment 121 is cylindrical. The motor compartment 121 accommodates the motor 106.

The grip 122 is cylindrical. The grip 122 is grippable by the user of the electric work machine 1. The grip 122 protrudes rearward from the motor compartment 121.

The battery holder 123 is connected to the rear end of the grip 122. The battery mount 105 is located in a rear portion of the battery holder 123. The battery 60 that supplies electric power to the motor 106 is attached to the battery mount 105. The battery 60 is attached to the battery holder 123 with the battery mount 105. The battery 60 is detachable from the battery mount 105.

The battery holder 123 has a larger outer dimension than the grip 122 in the vertical direction.

The grip 122 includes a bend 125. The bend 125 connects to the battery holder 123. The bend 125 is located at the rear end of the grip 122. The grip 122 connects to the battery holder 123 with the bend 125 in between. The bend 125 is a neck portion of the housing 102 at the boundary between the grip 122 and the battery holder 123.

The gear housing cover 103 is located between the housing 102 and the gear housing 104. The gear housing cover 103 is attached to a front portion of the housing 102 to cover a front opening of the housing 102. The gear housing cover 103 is formed from a metal.

The gear housing 104 accommodates at least parts of the reducer 107 and the spindle 108. The gear housing 104 in the present embodiment accommodates an upper portion of the spindle 108. The gear housing 104 is attached to the front portion of the housing 102 with the gear housing cover 103. The gear housing 104 is formed from a metal.

The motor 106 is a power source for the electric work machine 101. The motor 106 is a brushless inner-rotor motor. The motor 106 includes a cylindrical stator 161, a rotor 162, and a rotor shaft 163. The rotor 162 is located inside the stator 161. The rotor shaft 163 is integral with the rotor 162. The rotor 162 and the rotor shaft 163 rotate about the rotation axis AX. The rotation axis AX of the motor 106 extends in the front-rear direction.

The reducer 107 is located in front of the motor 106. The reducer 107 connects the rotor shaft 163 and the spindle 108 together. The reducer 107 transmits a rotational force generated by the motor 106 to the spindle 108. The reducer 107 rotates the spindle 108 at a lower rotational speed than the rotor shaft 163. The reducer 107 in the present embodiment includes a bevel gear.

The spindle 108 rotates about a rotation axis BX with the rotational force generated by the motor 106. The rotation axis BX of the spindle 108 extends vertically. The rotation axis BX of the spindle 108 is orthogonal to the rotation axis AX of the motor 106. The bearing box 109 holds bearings that support the spindle 108.

The wheel cover 110 is mounted on the bearing box 109. The wheel cover 110 is fastened to the bearing box 109 with a clamping assembly 117. A tip tool (grinding wheel) 116 is attached to the lower end of the spindle 108. The wheel cover 110 surrounds apart of the tip tool 116. The tip tool 116 is disc-shaped. The tip tool 116 is, for example, a grinding disc. The wheel cover 110 is at least partially located behind the tip tool 116.

The lock switch 111 is located in the gear housing 104. The lock switch 111 is operable to regulate the rotation of the spindle 108. The user operates the lock switch 111. In response to the operation on the lock switch 111 to move downward, the lock switch 111 has its lower end placed in a hole in the bevel gear in the reducer 107. This regulates the rotation of the bevel gear and thus of the spindle 108.

The fan 112 is located in front of the motor 106. The fan 112 generates an airflow for cooling the motor 106. The fan 112 is fixed to a front portion of the rotor shaft 163. The fan 112 rotates as the rotor shaft 163 rotates.

The battery holder 123 has an inlet 118. The gear housing 104 has an outlet 119. The fan 112 rotates, and air outside the housing 102 flows into an internal space of the housing 102 through the inlet 118 and flows through the internal space of the housing 102 to cool the motor 106. The air passing through the internal space of the housing 102 flows out of the housing 102 through the outlet 119.

The controller 113 is accommodated in the battery holder 123. The controller 113 outputs control signals for controlling the motor 106.

The drive switch 114 is located in the motor compartment 121. The drive switch 114 is operable by the user to drive the motor 106. The drive switch 114 protrudes upward from an upper portion of motor compartment 121. The drive switch 114 is slidable in the front-rear direction. The user operates the drive switch 114 while holding the grip 122. The user operates the drive switch 114 to drive the motor 106. The user releases the drive switch 114 to stop the drive of the motor 106.

### Housing and Sheet

The housing 102 includes a pair of housing halves. The housing 102 includes a left housing 102L and a right housing 102R. The right housing 102R is located on the right of the left housing 102L.

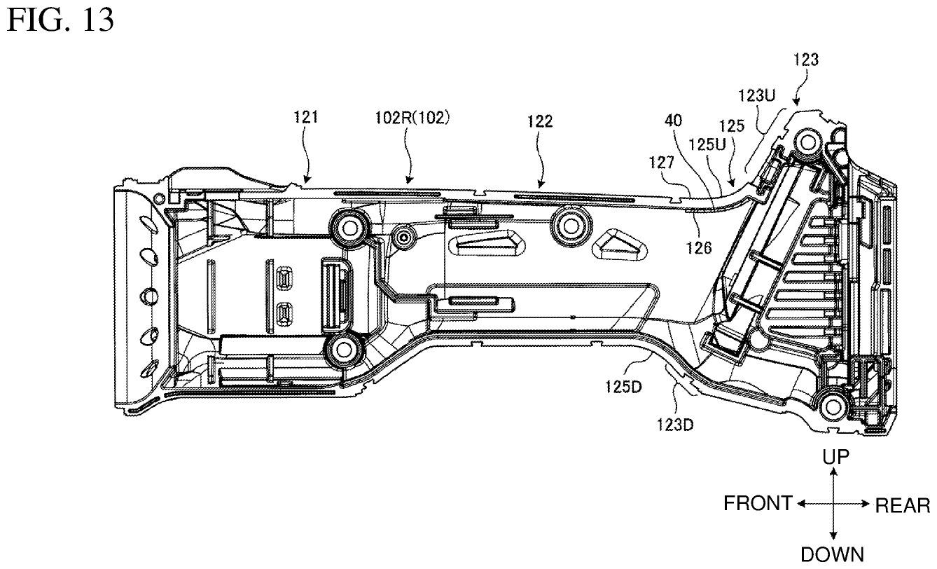

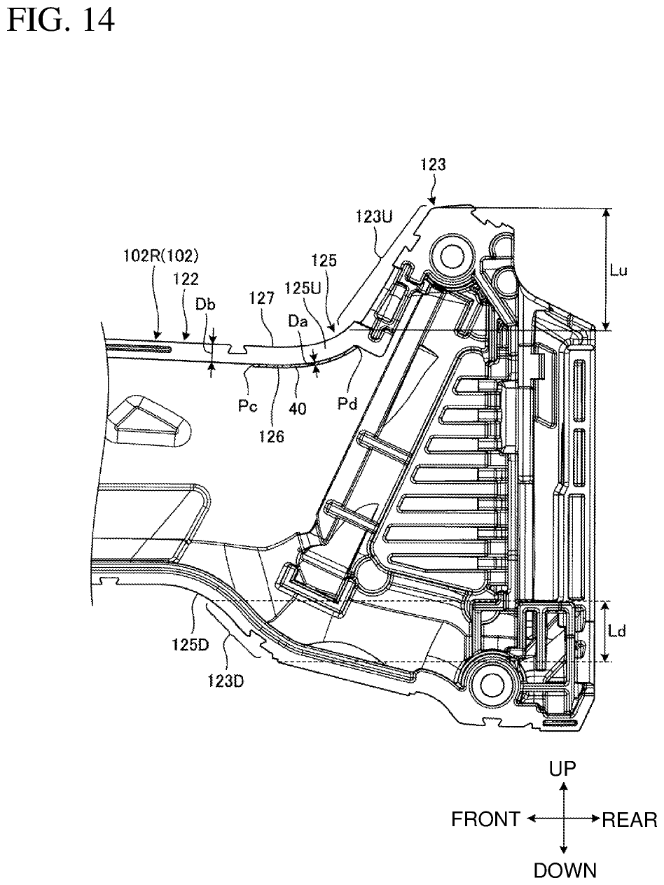

FIG. 13 is a left view of the right housing 102R in the embodiment. FIG. 14 is an enlarged partial left view of the right housing 102R in the embodiment.

The housing 102 has the internal space. The motor compartment 121 is cylindrical and has an internal space in which the motor 106 is located. The grip 122 is cylindrical and has an internal space in which a cable is located. The battery holder 123 has an internal space in which the controller 113 is located.

The grip 122 has an inner surface 126 and an outer surface 127. The inner surface 126 faces the internal space of the grip 122. The outer surface 127 faces the space external to the grip 122.

The grip 122 is elongated in the front-rear direction. The grip 122 connects to the battery holder 123 with the bend 125 in between. The bend 125 includes an upper bend 125U and a lower bend 125D in the vertical direction. The upper bend 125U is located above the center of the grip 122. The lower bend 125D is located below the center of the grip 122.

The battery holder 123 has a larger outer dimension than the grip 122 in the vertical direction. The battery holder 123 includes an upper extension 123U and a lower extension 123D in the vertical direction. The upper extension 123U extends upward from the upper bend 125U. The lower extension 123D extends downward from the lower bend 125D.

As shown in FIG. 14, the upper extension 123U has a dimension Lu larger than a dimension Ld of the lower extension 123D in the vertical direction.

The sheet 40 in the present embodiment is located on the inner surface 126 of the upper bend 125U.

The sheet 40 has a rectangular outer shape. The sheet 40 has a larger dimension in the front-rear direction than in the lateral direction. The sheet 40 is at least partially located on the centerline of the housing 102 in the lateral direction. In the present embodiment, the sheet 40 has the center aligned with the center of the housing 102 in the lateral direction. The sheet 40 has a smaller dimension than the grip 122 in the lateral direction. The sheet 40 has its front end at a defined position Pc on the grip 122 frontward from the bend 125. The sheet 40 has its rear end at a defined position Pd on the battery holder 123 rearward from the bend 125. The defined position Pc is defined rearward from the middle of the grip 122 in the front-rear direction. The defined position Pd is defined frontward from the middle of the battery holder 123 in the front-rear direction.

The sheet 40 has a thickness Da smaller than a thickness Db of the grip 122. The thickness Db of the grip 122 is the distance between the inner surface 126 and the outer surface 127. In the present embodiment, the thickness Da of the sheet 40 is from 3.3 to 50.0% inclusive of the thickness Db of the grip 122.

The sheet 40 has higher tensile strength than the synthetic resin contained in the grip 122. The tensile strength of the sheet 40 in the present embodiment is at least twice that of the synthetic resin contained in the grip 122.

As in the embodiment described above, the sheet 40 is a UD sheet as described with reference to FIG. 8.

The sheet 40 is fixed on the inner surface 126 of the upper bend 125U. The sheet 40 is located on the inner surface 126 of the upper bend 125U with the front-rear direction of the housing 102 aligned with the extending direction D1 of the fibers 41. The sheet 40 is bonded to the inner surface 126 with, for example, an adhesive. The sheet 40 may be joined to the inner surface 126 by a joining technique such as heat welding.

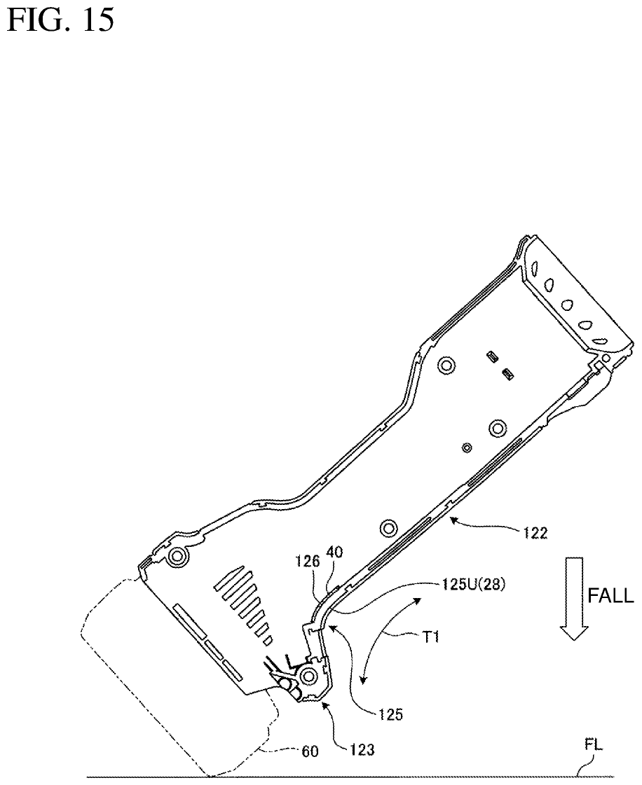

FIG. 15 is a diagram describing the effects of the sheet 40 in the present embodiment. As shown in FIG. 15, when the electric work machine 101 falls and the battery 60 hits the floor surface FL, the grip 122 may deform and bend upward with respect to the battery holder 123. In other words, when the battery 60 receives an impact from the floor surface FL, the bend 125 may deform and bend.

The bend 25 then has a portion that expands, and another portion that compresses. In the present embodiment, the expandable portion 28 includes the upper bend 125U.

As shown in FIG. 15, when the bend 125 deforms and bends, the inner surface 126 of the upper bend 125U expands in the expansion direction T1. The sheet 40 is located on the inner surface 126 of the upper bend 125U that is the expandable portion 28.

In the example shown in FIG. 15, the expansion direction T1 is substantially aligned with the front-rear direction of the housing 102. The sheet 40 is located on the inner surface 126 of the upper bend 125U with the expansion direction T1 of the inner surface 126 of the upper bend 125U aligned with the extending direction D1 of the fibers 41. In the expansion direction T1 of the expandable portion 28, the tensile strength of the sheet 40 is higher than that of the synthetic resin contained in the grip 122.

The sheet 40 has higher tensile strength than the synthetic resin contained in the grip 122 in the expansion direction T1. Although the inner surface 126 of the upper bend 125U may deform and expand in the expansion direction T1 in the falling electric work machine 101, the sheet 40 reduces the likelihood of deformation of the inner surface 126 of the upper bend 125U.

In the present embodiment as well, the sheet 40 strengthens the bend 125 in the grip 122. Although the electric work machine 101 falls and an excess impact is applied to the grip 122, the bend 125 is less likely to deform. This reduces the likelihood of damaging the grip 122.

### Modification

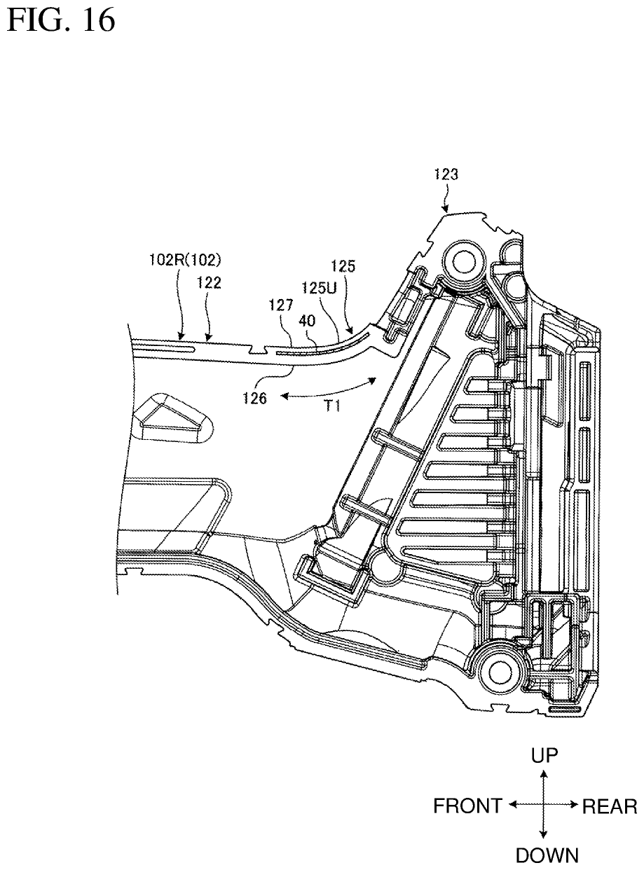

FIG. 16 is an enlarged partial left view of the right housing 102R in a modification of the present embodiment. In the example shown in FIG. 16, the sheet 40 is located inside the upper bend 125U between the inner surface 126 and the outer surface 127 of the upper bend 125U. The sheet 40 is located inside the upper bend 125U by, for example, insert molding.

When the electric work machine 101 falls and the battery 60 hits the floor surface FL, the upper bend 125U may deform and expand in the expansion direction T1. As shown in FIG. 16, the sheet 40 is located inside the upper bend 125U. This reduces the likelihood of deformation of the upper bend 125U. This reduces the likelihood of damaging the grip 122.

### Third Embodiment

The same or corresponding components as those in the above embodiments are given like reference numerals herein, and will be described briefly or will not be described. An electric work machine 201 according to the present embodiment is a planer as an example of an outdoor power tool.

### Electric Work Machine

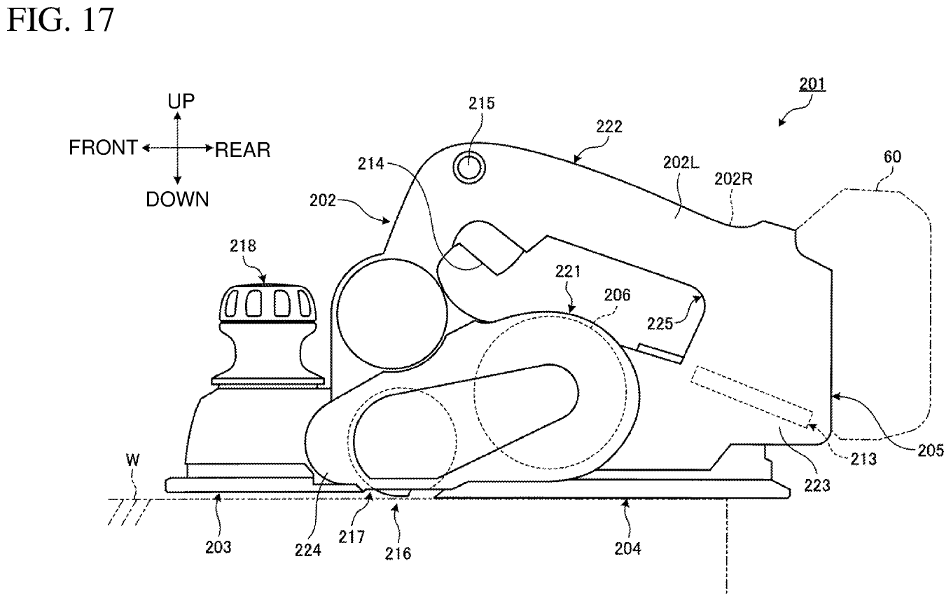

FIG. 17 is a side view of the electric work machine 201 according to the present embodiment. The electric work machine 201 includes a housing 202, a front base 203, a rear base 204, a battery mount 205, a motor 206, a controller 213, and a trigger switch 214.

The housing 202 is formed from a synthetic resin. The housing 202 includes a motor compartment 221, a grip 222, a battery holder 223, and a blade compartment 224.

The motor compartment 221 accommodates the motor 206.

The grip 222 is grippable by the user of the electric work machine 201. The grip 222 is at least partially located above the motor compartment 221. A front portion of the grip 222 is connected to the motor compartment 221. A rear portion of the grip 222 is connected to the battery holder 223. A center portion of the grip 222 curves upward.

The battery holder 223 is connected to the rear end of the motor compartment 221 and the rear end of the grip 222. The battery mount 205 is located in a rear portion of the battery holder 123. The battery 60 that supplies electric power to the motor 206 is attached to the battery holder 223 with the battery mount 205. The controller 213 is accommodated in the battery holder 223.

The grip 222 includes a bend 225 that connects to the battery holder 223. The bend 225 is located at the rear end of the grip 222. The grip 222 connects to the battery holder 223 with the bend 225 in between.

The blade compartment 224 accommodates a tip tool (planing cutter) 216. The blade compartment 224 is located frontward from the motor compartment 221.

The front base 203 and the rear base 204 are located in the front-rear direction. The bottom surface of the front base 203 and the bottom surface of the rear base 204 come in contact with the surface of a workpiece W. The tip tool 216 has its lower end protruding downward through an opening 217 between the front base 203 and the rear base 204. A planer blade is attached to the tip tool 216. The planer blade protruding downward through the opening 217 processes the surface of the workpiece W.

A cutting depth adjustment knob 218 is located on a front portion of the housing 202. A push member that pushes the front base 203 is located below the cutting depth adjustment knob 218. The cutting depth adjustment knob 218 is rotated to move the front base 203 in the vertical direction. As the front base 203 moves upward, the planer blade protrudes downward through the opening 217 by a greater length, thus achieving a greater cutting depth. As the front base 203 moves downward, the planer blade protrudes downward through the opening 217 by a shorter length, thus achieving a shorter cutting depth.

The trigger switch 214 is located on the grip 222. A lock-off button 215 is located above the trigger switch 214. The user holding the grip 222 operates the trigger switch 214 while operating the lock-off button 215 to drive the motor 206. In response to the release of the trigger switch 214, the motor 206 stops. The user cannot operate the trigger switch 214 unless the lock-off button 215 is operated.

The tip tool 216 is supported in the blade compartment 224 to allow rotation. The motor 206 and the tip tool 216 are connected with a power transmission assembly (not shown) including pulleys and a drive belt. When the motor 206 is driven, the tip tool 216 rotates.

### Housing and Sheet

The housing 202 includes a pair of housing halves. The housing 202 includes a left housing 202L and a right housing 202R. The right housing 202R is located on the right of the left housing 202L.

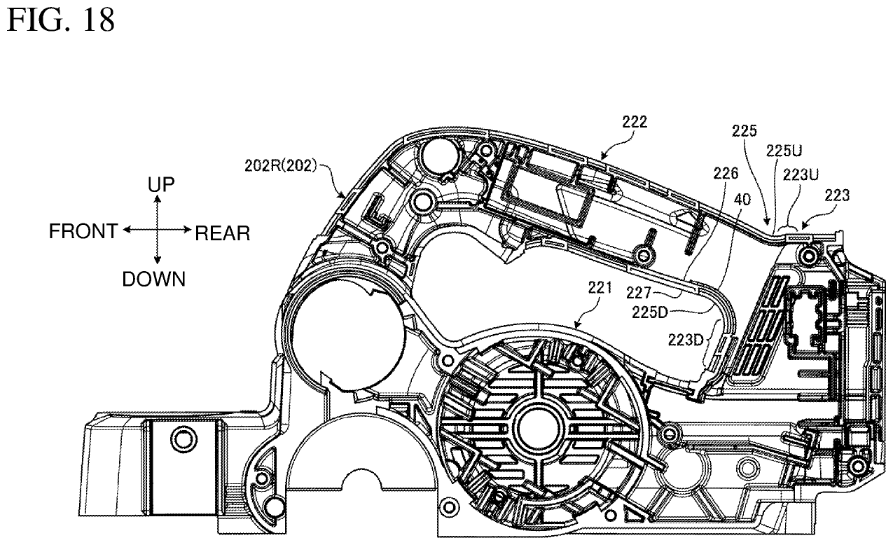

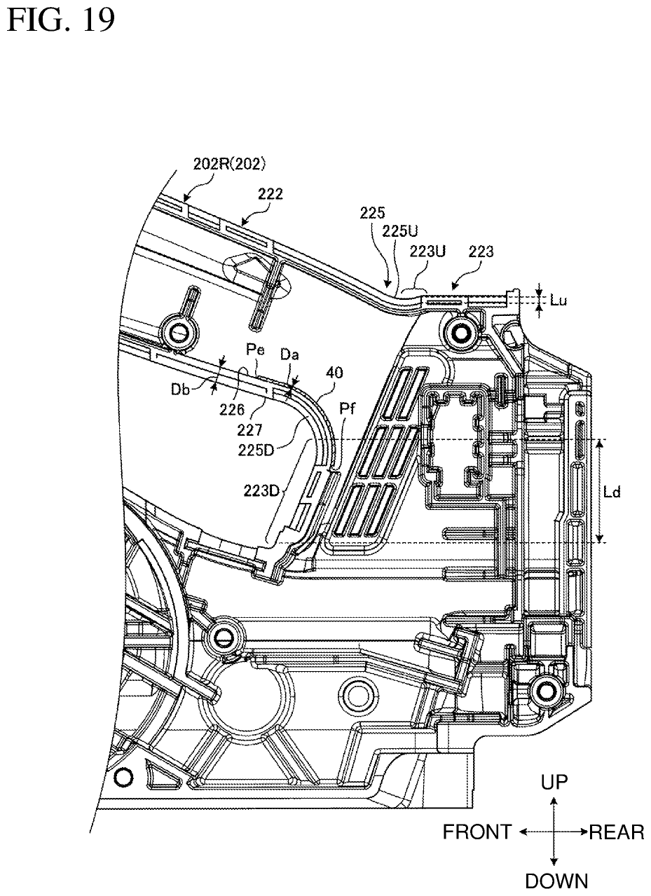

FIG. 18 is a left view of the right housing 202R in the present embodiment. FIG. 19 is an enlarged partial left view of the right housing 202R in the present embodiment.

The housing 202 has an internal space. The motor compartment 221 has an internal space in which the motor 206 is located. The grip 222 is cylindrical and has an internal space in which at least a part of the trigger switch 214 and a cable are located. The battery holder 223 has an internal space in which the controller 213 is located.

The grip 222 has an inner surface 226 and an outer surface 227. The inner surface 226 faces the internal space of the grip 222. The outer surface 227 faces the space external to the grip 222.

The grip 222 is elongated in a predetermined direction. The grip 222 extends downward toward the rear. The grip 222 connects to the battery holder 223 with the bend 225 in between.

The bend 225 includes an upper bend 225U and a lower bend 225D in the transverse direction orthogonal to the longitudinal direction of the grip 222. The upper bend 225U is located in one direction (upward) from the center of the grip 222. The lower bend 225D is located in the other direction (downward) from the center of the grip 222 in the transverse direction of the grip 222.

In the transverse direction (vertical direction) of the grip 222, the battery holder 223 has a larger outer dimension than the grip 222. The battery holder 223 includes an upper extension 223U and a lower extension 223D in the transverse direction of the grip 222. The upper extension 223U extends in one direction (upward) from the upper bend 225U. The lower extension 223D extends in the other direction (downward) from the lower bend 225D.

As shown in FIG. 19, in the transverse direction (vertical direction) of the grip 222, the lower extension 223D has a dimension Ld larger than a dimension Lu of the upper extension 223U.

The sheet 40 in the present embodiment is located on the inner surface 226 of the lower bend 225D.

The sheet 40 has a rectangular outer shape. The sheet 40 has a larger dimension in the front-rear direction than in the lateral dimension. The sheet 40 is at least partially located on the centerline of the housing 202 in the lateral direction. In the present embodiment, the sheet 40 has the center aligned with the center of the housing 202 in the lateral direction. The sheet 40 has a smaller dimension than the grip 222 in the lateral direction. The sheet 40 has its front end at a defined position Pe on the grip 222 frontward from the bend 225. The sheet 40 has its rear end at a defined position Pf on the battery holder 223 rearward from the bend 225. The defined position Pe is defined rearward from the middle of the grip 222 in the front-rear direction. The defined position Pf is defined frontward from the middle of the battery holder 223 in the front-rear direction.

As shown in FIG. 19, the sheet 40 has a thickness Da smaller than a thickness Db of the grip 222. The thickness Db of the grip 222 is the distance between the inner surface 226 and the outer surface 227. In the present embodiment, the thickness Da of the sheet 40 is from 3.3 to 50.0% inclusive of the thickness Db of the grip 222.

The sheet 40 has higher tensile strength than the synthetic resin contained in the grip 222. The tensile strength of the sheet 40 is at least twice that of the synthetic resin contained in the grip 222.

As in the embodiments described above, the sheet 40 is a UD sheet as described with reference to FIG. 8.

The sheet 40 is fixed to the inner surface 226 of the lower bend 225D. The sheet 40 is located on the inner surface 226 of the lower bend 225D with the longitudinal direction (front-rear direction) of the grip 222 aligned with the extending direction D1 of the fibers 41. The sheet 40 is bonded to the inner surface 226 with an adhesive. The sheet 40 may be joined to the inner surface 226 by a joining technique such as heat welding.

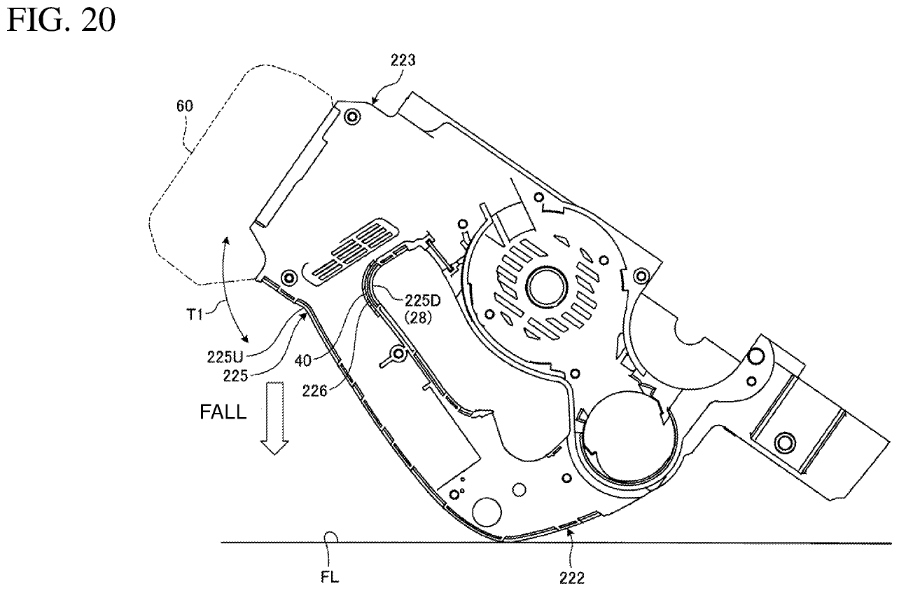

FIG. 20 is a diagram describing the effects of the sheet 40 in the present embodiment. As shown in FIG. 20, when the electric work machine 201 falls and the grip 222 hits the floor surface FL, the battery holder 223 may deform and bend with respect to the grip 222. In other words, when the grip 222 receives an impact from the floor surface FL, the bend 225 may deform and bend.

The bend 225 then has a portion that expands, and another portion that compresses. In the present embodiment, the expandable portion 28 includes the lower bend 225D.

As shown in FIG. 20, when the bend 225 deforms and bends, the inner surface 226 of the lower bend 225D expands in the expansion direction T1. The sheet 40 is located on the inner surface 226 of the lower bend 225D that is the expandable portion 28.

In the example shown in FIG. 20, the expansion direction T1 is substantially aligned with the front-rear direction. The sheet 40 is located on the inner surface 226 of the lower bend 225D with the expansion direction T1 of the inner surface 226 of the lower bend 225D aligned with the extending direction D1 of the fibers 41. The sheet 40 has higher tensile strength than the synthetic resin contained in the grip 222 in the expansion direction T1 of the expandable portion 28.

The sheet 40 has higher tensile strength than the synthetic resin contained in the grip 222 in the expansion direction T1. Although the inner surface 226 of the lower bend 225D deforms and expands in the expansion direction T1 in the falling electric work machine 201, the sheet 40 reduces the likelihood of deformation of the inner surface 226 of the lower bend 225D.

In the present embodiment as well, the sheet 40 strengthens the bend 225 in the grip 222. Although the electric work machine 201 falls and an excess impact is applied to the grip 222, the bend 225 is less likely to deform. This reduces the likelihood of damaging the grip 222.

### Fourth Embodiment

The same or corresponding components as those in the above embodiments are given like reference numerals herein, and will be described briefly or will not be described. An electric work machine 301 according to the present embodiment is a chain saw as an example of an outdoor power tool.

### Electric Work Machine

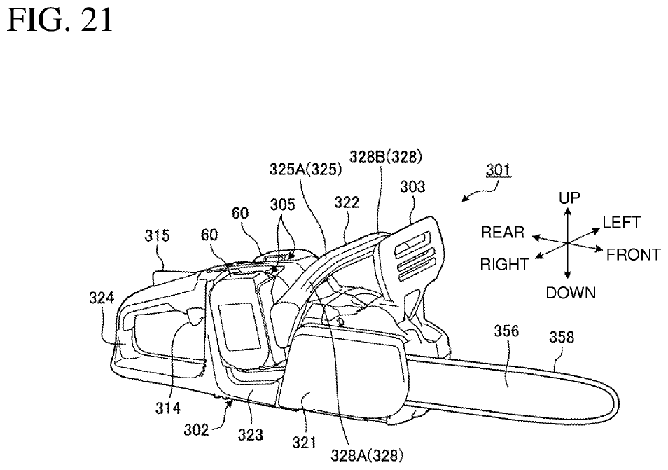

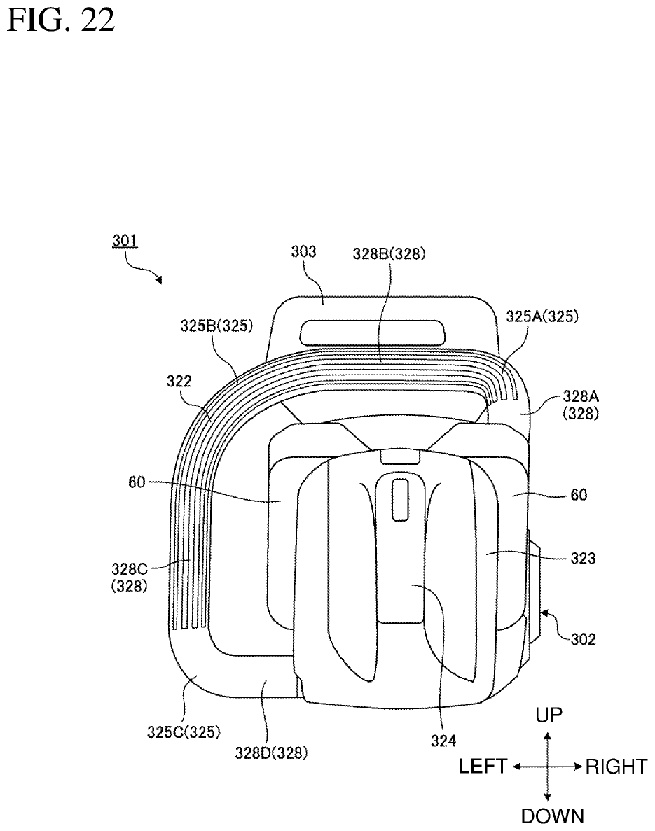

FIG. 21 is a perspective view of the electric work machine 301 according to the present embodiment. FIG. 22 is a rear view of the electric work machine 301 according to the present the embodiment. The electric work machine 301 includes a housing 302, a hand guard 303, a grip 322, a battery mount 305, a trigger switch 314, a trigger lock lever 315, a guide bar 356, and a tip tool (saw chain) 358.

The housing 302 is formed from a synthetic resin. The housing 302 includes a motor compartment 321, a battery holder 323, and a rear grip 324.

The motor compartment 321 accommodates a motor. The battery holder 323 is connected to the rear end of the motor compartment 321. The battery holder 323 includes the battery mount 305 to which the battery 60 is attached. The battery holder 323 accommodates a controller. The rear grip 324 is connected to the rear end of the battery holder 323. The trigger switch 314 and the trigger lock lever 315 are located in the rear grip 324. The trigger switch 314 is operable to allow operation of the trigger lock lever 315.

The guide bar 356 extends frontward from the housing 302. The guide bar 356 is a plate elongated in the front-rear direction. The tip tool 358 includes multiple cutters that are connected to one another. The tip tool 358 is located along the peripheral edge of the guide bar 356. In response to an operation on the trigger switch 314, the motor is driven. The motor and the tip tool 358 are connected with a power transmission assembly (not shown) including a sprocket. The motor is driven, and the tip tool 358 moves around the peripheral edge of the guide bar 356.

The grip 322 is formed from a synthetic resin. The grip 322 is grippable by the user. The grip 322 is a pipe. The grip 322 connects to the battery holder 323. The grip 322 has its left end connected to the left side surface of the battery holder 323. The grip 322 has its right end connected to the right side surface of the battery holder 323.

The grip 322 includes multiple bends 325 and multiple straight portions 328. The bends 325 in the present embodiment include a first bend 325A, a second bend 325B, and a third bend 325C. The straight portions 328 include a first straight portion 328A, a second straight portion 328B, a third straight portion 328C, and a fourth straight portion 328D.

The first straight portion 328A extends upward toward the front. The second straight portion 328B extends in the lateral direction. The third straight portion 328C extends downward toward the rear. The fourth straight portion 328D extends in the lateral direction. The first straight portion 328A has its lower end connected to the right side surface of the battery holder 323. The first straight portion 328A has its upper end continuous with the right end of the second straight portion 328B with the first bend 325A in between. The second straight portion 328B has its left end continuous with the upper end of the third straight portion 328C with the third bend 325C in between. The third straight portion 328C has its lower end continuous with the left end of the fourth straight portion 328D with the third bend 325C in between. The fourth straight portion 328D has its right end connected to the left side surface of the battery holder 323.

### Grip and Sheet

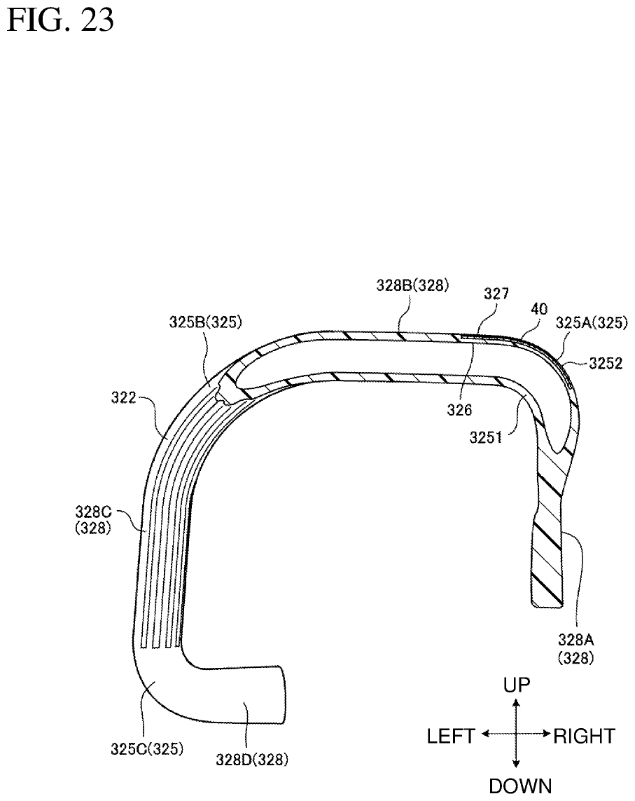

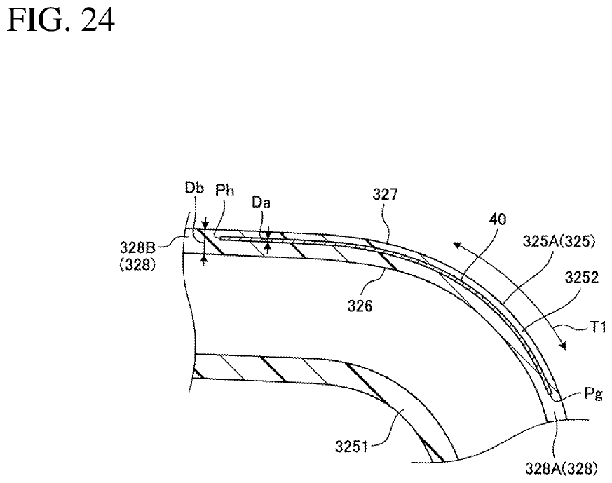

FIG. 23 is a partially cut-away view of the grip 322 in the present embodiment. FIG. 24 is a partial sectional view of the grip 322 in the present embodiment.

The grip 322 is a pipe and has an internal space. The grip 322 has an inner surface 326 and an outer surface 327. The inner surface 326 faces the internal space of the grip 322. The outer surface 327 faces the space external to the grip 322.

The sheet 40 in the present embodiment is located in the first bend 325A. The first bend 325A includes an inner peripheral portion 3251 and an outer peripheral portion 3252. The inner peripheral portion 3251 faces the housing 302. The outer peripheral portion 3252 is located outward from the inner peripheral portion 3251 with respect to the housing 302. The inner peripheral portion 3251 has a greater curvature than the outer peripheral portion 3252. The sheet 40 in the present embodiment is located in the outer peripheral portion 3252 of the first bend 325A. The sheet 40 is located inside the outer peripheral portion 3252 between the inner surface 326 and the outer surface 327.

The sheet 40 has one end at a defined position Pg in the first straight portion 328A, and the other end at a defined position Ph in the second straight portion 328B.

The sheet 40 has a thickness Da smaller than a thickness Db of the grip 322. The thickness Db of the grip 322 is the distance between the inner surface 326 and the outer surface 327. In the present embodiment, the thickness Da of the sheet 40 is from 3.3 to 50.0% inclusive of the thickness Db of the grip 322.

The sheet 40 has higher tensile strength than the synthetic resin contained in the grip 322. The tensile strength of the sheet 40 in the present embodiment is at least twice that of the synthetic resin contained in the grip 322.

As in the embodiments described above, the sheet 40 is a UD sheet as described with reference to FIG. 8.

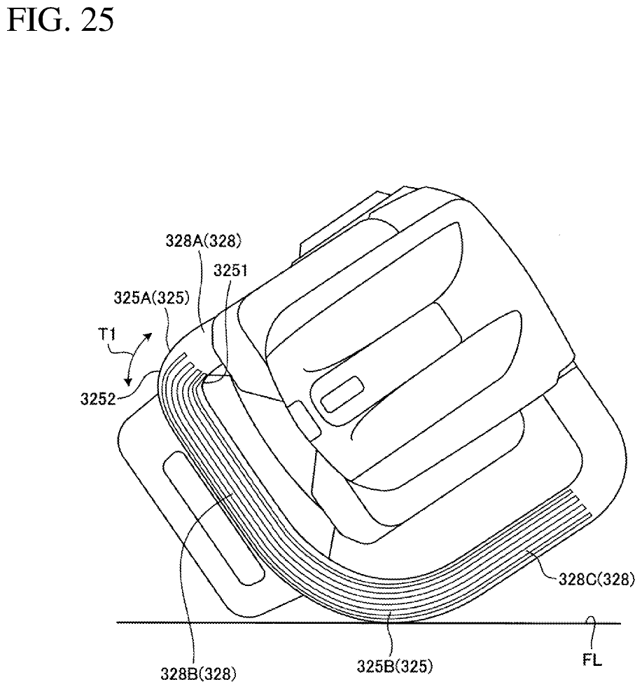

FIG. 25 is a diagram describing the effects of the sheet 40 in the present embodiment. As shown in FIG. 25, when the electric work machine 301 falls and the second bend 325B hits the floor surface FL, the first bend 325A may receive an impact and deform and bend.

The first bend 325A then has a portion that expands, and another portion that compresses. The expandable portion 28 in the present embodiment includes the outer peripheral portion 3252 of the first bend 325A. The outer peripheral portion 3252 is pulled by the first straight portion 328A and the second straight portion 328B and thus expands.

As shown in FIG. 25, when the first bend 325A deforms and bends, the outer peripheral portion 3252 of the first bend 325A expands in the expansion direction T1. The sheet 40 is located inside the outer peripheral portion 3252 of the first bend 325A that is the expandable portion 28.

The sheet 40 is located inside the outer peripheral portion 3252 of the first bend 325A with the expansion direction T1 of the outer peripheral portion 3252 aligned with the extending direction D1 of the fibers 41. The sheet 40 has higher tensile strength than the synthetic resin contained in the grip 322 in the expansion direction T1 of the expandable portion 28.

The sheet 40 has higher tensile strength than the synthetic resin contained in the grip 322 in the expansion direction T1. Although the outer peripheral portion 3252 of the first bend 325A may deform and expand in the expansion direction T1 in the falling electric work machine 301, the sheet 40 reduces the likelihood of deformation of the outer peripheral portion 3252 of the first bend 325A.

In the present embodiment as well, the sheet 40 strengthens the first bend 325A in the grip 322. Although the electric work machine 301 falls and an excess impact is applied to the grip 322, the first bend 325A is less likely to deform. This reduces the likelihood of damaging the grip 322.

### Modification

The sheet 40 may be located on the outer surface 327 of the outer peripheral portion 3252 of the first bend 325A.

The sheet 40 may be located in an outer peripheral portion of the second bend 325B or in an outer peripheral portion of the third bend 325C.

### Fifth Embodiment

The same or corresponding components as those in the above embodiments are given like reference numerals herein, and will be described briefly or will not be described.

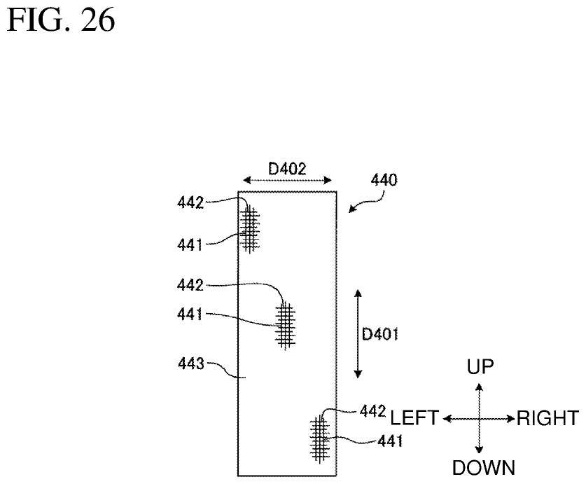

FIG. 26 is a schematic diagram of a sheet 440 in the present embodiment. The sheet 40 in the embodiments described above is a UD sheet. As shown in FIG. 26, the sheet 440 includes a synthetic resin base 443, first fibers 441, and second fibers 442. The first fibers 441 are located in the base 443 and extend in a first extending direction D401. The second fibers 442 are located in the base 443 and extend in a second extending direction D402 that is different from the first extending direction D401. In the example shown in FIG. 26, the first extending direction D401 and the second extending direction D402 are orthogonal. The first extending direction D401 and the second extending direction D402 may not be orthogonal.

The sheet 440 is located in the bend with the expansion direction T1 of the expandable portion 28 aligned with the first extending direction D401 of the first fibers 441. The sheet 440 thus has higher tensile strength than the synthetic resin contained in a grip in the expansion direction T1 of the expandable portion 28. Although the bend expands in an expansion direction T2, the sheet 440 has higher tensile strength than the synthetic resin contained in the grip in the expansion direction T2 due to the alignment of the expansion direction T2 and the second extending direction D402. In other words, the sheet 440 shown in FIG. 26 can retain the strength of the bend, although the bend deforms and expands in different directions.

In addition to the first and second fibers 441 and 442, third fibers extending in a third extending direction may be located in the base 443.

### Sixth Embodiment

The same or corresponding components as those in the above embodiments are given like reference numerals herein, and will be described briefly or will not be described.

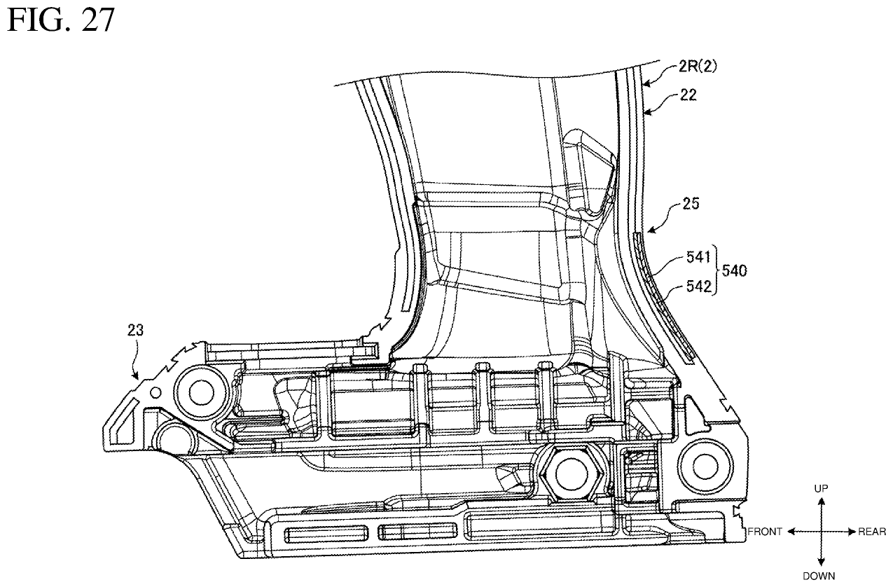

FIG. 27 is a sectional view of a sheet 540 in the present embodiment. As shown in FIG. 27, the sheet 540 includes a first sheet 541 and a second sheet 542 overlapping the first sheet 541. For example, the first sheet 541 and the second sheet 542 may overlap in the extending direction of the fibers of the first sheet 541 different from the extending direction of the fibers of the second sheet 542.

### Seventh Embodiment

The same or corresponding components as those in the above embodiments are given like reference numerals herein, and will be described briefly or will not be described. In the embodiments described above, the sheet has a rectangular outer shape. The sheet may not have a rectangular outer shape but may have a polygonal outer shape, such as a hexagonal or an octagonal, a circular, or an elliptical outer shape.

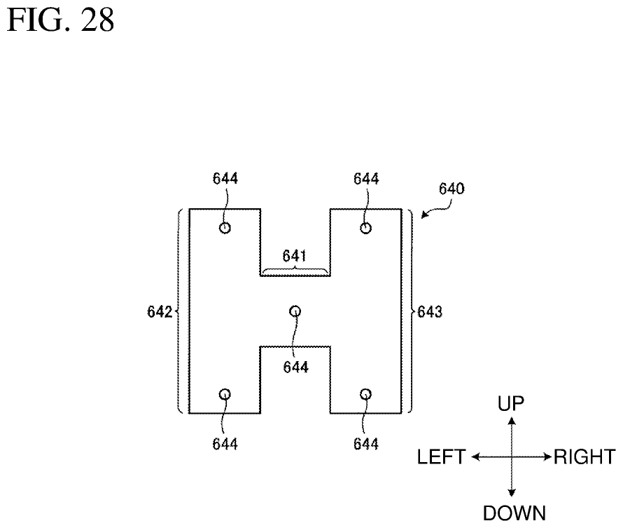

FIG. 28 is a schematic diagram of a sheet 640 in the present embodiment. As shown in FIG. 28, the sheet 640 includes a central band 641, a left band 642, and a right band 643. The left band 642 connects to the left end of the central band 641. The right band 643 connects to the right end of the central band 641. The central band 641 is rectangular and elongated in the lateral direction. The left band 642 is rectangular and elongated in the vertical direction. The right band 643 is rectangular and elongated in the vertical direction. Each of the central band 641, the left band 642, and the right band 643 has one or more openings 644. Each opening 644 is a through-hole connecting the front and back surfaces of the sheet 640.

When the sheet 640 is located inside a bend by insert molding, the synthetic resin comes in contact with the front and back surfaces of the sheet 640 and is located inside the openings 644. This firmly fixes the sheet 640 in the bend.

### Other Embodiments

In the embodiments described above, the sheet may be formed from a metal. The sheet is formed from, for example, aluminum, iron, titanium, or magnesium. The sheet formed from a metal film has higher tensile strength and higher strength than the synthetic resin contained in the handle.

In the embodiments described above, the tensile strength of the sheet may be less than twice that of the synthetic resin contained in the housing (the motor compartment, the battery holder, and the grip). The sheet may have higher tensile strength than the synthetic resin contained in the housing.

In the embodiments described above, the bend is located in the grip. The bend may be located in a predetermined portion of the housing different from the grip. The bend may be formed in at least one of the motor compartment, the battery holder, or the grip. The bend may connect any two of the motor compartment, the battery holder, or the grip. Although the bend is located in a predetermined portion of the housing different from the grip, locating the sheet in the bend strengthens the housing 2.

In the embodiments described above, the housing includes the motor compartment, the battery holder, and the grip, and the motor compartment, the battery holder, and the grip are formed from the same material. The sheet has higher tensile strength than the motor compartment, the battery holder, and the grip. The sheet may have higher tensile strength than at least one of the motor compartment, the battery holder, and the grip. For example, when the motor compartment, the battery holder, and the grip are formed form different materials, and the sheet is located in the bend in the motor compartment, the sheet may have higher tensile strength than the motor compartment and may have lower tensile strength than the battery holder or the grip. When the sheet is located in the bend connecting the motor compartment and the grip, the sheet may have higher tensile strength than the motor compartment and the grip and may have lower tensile strength than the battery holder.

In the embodiments described above, the motor compartment is connected to the grip, and the grip is connected to the battery holder. The motor compartment and the battery holder may be connected to each other.

In the embodiments described above, the sheet may be formed from a synthetic resin. The synthetic resin contained in the sheet may be the same material as the synthetic resin contained in the grip or may be a different material. In other words, the sheet may be formed from the same material as or a different material from the housing. The sheet may have the same tensile strength as the synthetic resin contained in the housing. The synthetic resin sheet in the bend also reinforces the bend.

In the embodiments described above, the electric work machine may be a power tool such as a driver drill, a vibration driver drill, an angle drill, a screwdriver, a hammer, a hammer drill, a wheel saw, or a reciprocating saw. In the embodiments described above, the electric work machine may be an outdoor power tool such as a hedge trimmer, a lawn mower, a weed trimmer, or a blower. In the embodiments described above, the electric work machine may be a cleaner.

In the embodiments described above, the electric work machine includes the motor compartment accommodating the motor. The electric work machine may not include the motor compartment. The components in the embodiments described above may be included in, for example, a lighting apparatus having a detachable battery without a motor compartment as described in Japanese Unexamined Patent Application Publication No. 2019-040885 or an audio output apparatus having a detachable battery without a motor compartment as described in Japanese Unexamined Patent Application Publication No. 2020-028090. When the bend is included in such a lighting apparatus or an audio output apparatus, the bend can be reinforced with the sheet. The reinforcement with the sheet reduces the likelihood of damaging the lighting apparatus or the audio output apparatus.

In the embodiments described above, the bend is reinforced with the sheet that is a sheet reinforcing member. The reinforcing member may not be a sheet. The reinforcing member may be, for example, a block or fibers.

### REFERENCE SIGNS LIST

1 electric work machine
2 housing
2L left housing
2R right housing
3 rear case
4 hammer case
5 battery mount
6 motor
7 reducer
8 spindle
9 striker
10 anvil
11 chuck sleeve
12 fan
13 controller
14 trigger switch
15 forward-reverse switch lever
16 lamp
18 inlet
19 outlet
20 insertion hole
21 motor compartment
22 grip
23 battery holder
23B rear extension (second extension)
23F front extension (first extension)
23L left extension
23R right extension
24 bend (bend in one end)
25 bend (bend in the other end)
25B rear bend (second bend)
25F front bend (first bend)
25L left bend
25R right bend
26 inner surface
27 outer surface
28 expandable portion
29 compressible portion
30 elastomer portion
30L left elastomer portion
30R right elastomer portion
31 motor elastomer portion
32 grip elastomer portion
33 battery elastomer portion
40 sheet
40L left sheet
40R right sheet
41 fiber
43 base
60 battery
61 stator
62 rotor
63 rotor shaft
101 electric work machine
102 housing
102L left housing
102R right housing
103 gear housing cover
104 gear housing
105 battery mount
106 motor
107 reducer
108 spindle
109 bearing box
110 wheel cover
111 lock switch
112 fan
113 controller
114 drive switch
116 tip tool
117 clamping assembly
118 inlet
119 outlet
121 motor compartment
122 grip
123 battery holder
123D lower extension (second extension)
123U upper extension (first extension)
125 bend
125D lower bend (second bend)
125U upper bend (first bend)
126 inner surface
127 outer surface
161 stator
162 rotor
163 rotor shaft
201 electric work machine
202 housing
202L left housing
202R right housing
203 front base
204 rear base
205 battery mount
206 motor
213 controller
214 trigger switch
215 lock-off button
216 tip tool
217 opening
218 cutting depth adjustment knob
221 motor compartment
222 grip
223 battery holder
223D lower extension (first extension)
223U upper extension (second extension)
224 blade compartment
225 bend
225D lower bend (first bend)
225U upper bend (second bend)
226 inner surface
227 outer surface
301 electric work machine
302 housing
303 hand guard
322 grip
305 battery mount
314 trigger switch
315 trigger lock lever
321 motor compartment
323 battery holder
324 rear grip
325 bend
325A first bend
325B second bend
325C third bend
326 inner surface
327 outer surface
328 straight portion
328A first straight portion
328B second straight portion
328C third straight portion
328D fourth straight portion
356 guide bar
358 tip tool
440 sheet
441 first fiber
442 second fiber
443 base
540 sheet
541 first sheet
542 second sheet
640 sheet
641 central band
642 left band
643 right band
644 opening
3251 inner peripheral portion
3252 outer peripheral portion
AX rotation axis
BX rotation axis
D1 extending direction
D2 width direction
D401 first extending direction
D402 second extending direction
Da thickness
Db thickness
Lb dimension
Ld dimension
Lf dimension
Lu dimension
Pa defined position
Pb defined position
Pc defined position
Pd defined position
Pe defined position
Pf defined position
Pg defined position
Ph defined position
T1 expansion direction
T2 expansion direction
W workpiece

1. An electric work machine, comprising:
a motor compartment accommodating a motor;
a battery holder configured to receive a battery for supplying electric power to the motor;
a grip grippable by an operator; and
a sheet for reinforcement, the sheet being located in a bend, the bend being in at least one of the motor compartment, the battery holder, or the grip or connecting two of the motor compartment, the battery holder, or the grip.

2. The electric work machine according to claim 1, wherein the grip is elongated along a first axis and connects to the battery holder with the bend in between,
the bend includes a first bend located in a portion in a first direction from a center of the grip along a second axis orthogonal to the first axis and a second bend located in a portion in a second direction from the center of grip along the second axis,
the battery holder includes a first extension extending in the first direction from the first bend along the second axis and a second extension extending in the second direction from the second bend along the second axis,
the first extension has a larger dimension than the second extension along the second axis, and
the sheet is located in the second bend.

3. The electric work machine according to claim 2, wherein the sheet is located on an outer surface of the second bend.

4. The electric work machine according to claim 2, wherein the sheet is located inside the second bend.

5. The electric work machine according to claim 1, wherein the grip is elongated along a first axis and connects to the battery holder with the bend in between,
the bend includes a first bend located in a portion in a first direction from a center of the grip along a second axis orthogonal to the first axis and a second bend located in a portion in a second direction from the center of grip along the second axis,
the battery holder includes a first extension extending in the first direction from the first bend along the second axis and a second extension extending in the second direction from the second bend along the second axis,
the first extension has a larger dimension than the second extension along the second axis, and
the sheet is located in the first bend.

6. The electric work machine according to claim 5, wherein the sheet is located on an inner surface of the first bend.

7. The electric work machine according to claim 5, wherein the sheet is located inside the first bend.

8. The electric work machine according to claim 1, wherein
the sheet has higher tensile strength than at least one of the motor compartment, the battery holder, or the grip.

9. An electric work machine, comprising:
a motor compartment accommodating a motor;
a battery holder configured to receive a battery for supplying electric power to the motor;
a grip grippable by an operator; and
a sheet having higher tensile strength than at least one of the motor compartment, the battery holder, or the grip, the sheet being located in a bend, the bend being in at least one of the motor compartment, the battery holder, or the grip or connecting two of the motor compartment, the battery holder, or the grip.

10. The electric work machine according to claim 8, wherein
the sheet has tensile strength being at least twice tensile strength of the motor compartment, the battery holder, and the grip.

11. The electric work machine according to claim 8, wherein
the sheet is located in an expandable portion of the bend, and the expandable portion expands in deformation of the bend.

12. The electric work machine according to claim 11, wherein the sheet has higher tensile strength than tensile strength of the motor compartment, the battery holder, and the grip in an expansion direction of the expandable portion.

13. The electric work machine according to claim 11, wherein
the sheet includes
a base comprising a synthetic resin, and
fibers located in the base and extending in a predetermined extending direction, and
the sheet is located in the bend with the expansion direction of the expandable portion aligned with the extending direction of the fiber.

14. The electric work machine according to claim 11, wherein
the bend includes
an inner surface facing an internal space of the bend, and
an outer surface facing a space external to the bend, and
the sheet is located inside the bend between the inner surface and the outer surface.

15. The electric work machine according to claim 11, wherein
the bend includes
an inner surface facing an internal space of the bend, the inner surface being a part of the expandable portion, and
an outer surface facing a space external to the bend, and
the sheet is located on the inner surface.

16. The electric work machine according to claim 11, wherein
the bend includes
an inner surface facing an internal space of the bend, and
an outer surface facing a space external to the bend, the outer surface being a part of the expandable portion, and
the sheet is located on the outer surface.

17. The electric work machine according to claim 15, further comprising:
an elastomer portion covering the sheet.

18. The electric work machine according to claim 1, wherein
the grip is cylindrical, and
the sheet has a thickness smaller than a thickness of the grip.

19. The electric work machine according to claim 18, wherein
the sheet has the thickness being from 3.3 to 50.0% inclusive of a thickness of the grip.

20. An electric work machine, comprising:
a housing accommodating a motor, configured to hold a battery for supplying electric power to the motor, and including a bend; and
a reinforcing member comprising a material different from a material of the housing and reinforcing the bend.
